(19) United States
(12) Patent Application Publication
(10) Pub. No.: US 2015/0339671 A1
(43) Pub. Date: Nov. 26, 2015

(54) DYNAMIC FRAUD ALERT SYSTEM

(71) Applicant: DOUBLE CHECK SOLUTIONS, LLC, Newport Beach, CA (US)

(72) Inventors: MARK KRIETZMAN, PALOS VERDES, CA (US); JOEL SCHWARTZ, NEWPORT BEACH, CA (US)

(21) Appl. No.: 14/701,466

(22) Filed: Apr. 30, 2015

Related U.S. Application Data
(63) Continuation of application No. PCT/US2013/068357, filed on Nov. 4, 2013.
(60) Provisional application No. 61/721,026, filed on Nov. 1, 2012.
(60) Provisional application No. 61/736,081, filed on Dec. 12, 2012.
(60) Provisional application No. 61/843,032, filed on Jul. 4, 2013.

(51) Int. Cl. G06Q 20/40

(52) U.S. Cl. CPC G06Q 20/4016

(57) ABSTRACT

A Dynamic Fraud Alert System (“DFAS”) for producing a fraud alert based on a received request to investigate (“RTI”) a potential customer, where the RTI is received from a requesting entity, and where the RTI includes potential customer information provided by the potential customer is described.

### CROSS-REFERENCE To RELATED APPLICATION

This application claims the priority to U.S. (“U.S.”) Provisional Patent Application Ser. No. 61/721,026, titled “Payment Alerts And Reminders For Accounts With Imbalances,” filed on Nov. 1, 2012, to inventors Mark Krietzman and Joel Schwartz, the disclosure of which is incorporated by reference herein in its entirety.

Additionally, this application also claims the priority to U.S. Provisional Patent Application Ser. No. 61/736,081, titled “Reminders Alert Provider For Bank Accounts With Imbalances,” filed on Dec. 12, 2012, to inventors Mark Krietzman and Joel Schwartz, the disclosure of which is incorporated by reference herein in its entirety.

Furthermore, this application also claims the priority to U.S. Provisional Patent Application Ser. No. 61/843,032, titled “Financial And Credit Management,” filed on Jul. 4, 2013, to inventors Mark Krietzman and Joel Schwartz, the disclosure of which is incorporated by reference herein in its entirety.

Furthermore, this application also claims the priority to U.S. Provisional Patent Application Ser. No. 61/843,032, titled “Financial And Credit Management,” filed on Jul. 4, 2013, to inventors Mark Krietzman and Joel Schwartz, the disclosure of which is incorporated by reference herein in its entirety.

Still furthermore, this application also claim priority to concurrently filed PCT Application Ser. No. PCT/US13/68176, titled “FINANCIAL ALERT MANAGEMENT SYSTEM,” filed on Nov. 1, 2013, to inventors Mark Krietzman and Joel Schwartz, the disclosure of which is incorporated by reference herein it its entirety.

Still furthermore, this application also claim priority to concurrently filed PCT Application Ser. No. PCT/13/68178, titled “FINANCIAL MEASURE OF GOOD ACTION METRIC SYSTEM,” filed on Nov. 1, 2013, to inventors Mark Krietzman and Joel Schwartz, the disclosure of which is incorporated by reference herein it its entirety.

### BACKGROUND OF THE INVENTION

1. Field of the Invention

The present invention relates generally to the financial service industry and, more particularly, to a system and method for dramatically monitoring financial transactions for possible fraudulent activity.

2. Related Art

At present, the economy of today's modern society is very dependent on its financial system. This financial system includes numerous financial institutions that broadly speaking may be divided into three major types that include depositary institutions, contractual institutions, and investment institutions. Typically, depository institutions are deposit-taking financial institutions that accept and manage deposits and make loans. Examples of these deposit-taking financial institutions include banks, savings and loan, credit unions, trust companies, and mortgage loan companies. Examples of contractual institutions are pension funds. Furthermore, examples of investment institutions are investment banks, underwriters, and brokerage firms. Generally, all of these financial institutions are regulated by the national governments having jurisdiction to which these financial institutions are subject to. In the case of the United States (“U.S.”), these types of financial institutions are regulated by various agencies of the U.S. Federal government and at times the individual State governments having jurisdiction of these financial institutions.

At present, the U.S. payment system is the largest in the world. Each day, millions of transactions, valued in the trillions of dollars, are conducted between sellers and purchasers of goods, services, or financial assets. Most of the payments underlying those transactions flow between depository institutions, a large number of which maintain accounts with the Federal Reserve Banks of the Federal Reserve System (also known as the “Federal Reserve”) of the U.S. As such, the Federal Reserve performs an important role as an intermediary in clearing and settling interbank payments. Typically, depository institutions settle payment transactions efficiently by debiting the accounts of the depository institutions making payments and by crediting the accounts of depository institutions receiving payments.

Generally, the Federal Reserve utilizes three main payment and settlement systems. The first is Fedwire Funds Service (known generally as “Fedwire”), the second is the Automated Clearing House (“ACH”), and the third is other Check clearing services (including Check 21). Usually, participating financial institutions utilize Fedwire for large-value, time-critically payments, such as: payments to settle interbank purchase and sales of federal funds; to purchase, sell, or finance securities transactions; to disburse or repay large loans; and to settle real estate transactions. The U.S. Department of the Treasury and other federal agencies or government-sponsored enterprises also utilize Fedwire to disburse and collect funds. For other types of payments, typically, ACH is utilized.

ACH is an electronic payment system that was originally developed jointly by the private sector and the Federal Reserve in the 1970s as a more-efficient alternative to payments by checks. Since then, the ACH has evolved into a nationwide mechanism that processes credit and debit transfers electronically. ACH credit transfers are used to make direct deposit payroll payments and corporate payments to vendors. ACH debit transfers are used by consumers to authorize the payment of insurance premiums, mortgages, loans, and other bills from their account. The ACH is also used by businesses to concentrate funds at a primary bank and to make payments to other businesses. An example of an ACH is the Electronic Payments Network (“EPN”) that provides functions similar to those provided by the Federal Reserve Banks and is the only private-sector ACH operator in the U.S.

Check 21 services are based on 12 U.S.C. Chapter 50 (§§5001-5018), the Check Clearing for the 21^{st} Century Act (known as the “Check 21 Act”). The Check 21 Act allows the recipient (i.e., a payee) of an original paper check to create a digital version of the original check, a process known as check truncation, in an electronic format called a “substitute check,” thereby eliminating the need for further handling of the physical original check. Once a check is truncated, businesses and banks can work with either the digital image or a print reproduction of the digitized images. Digitized images can be exchanged between member banks, savings and loans, credit unions, servicers, clearinghouses, and the Federal Reserve Bank. It is appreciated by those skilled in the art that Check 21 services are not subject to ACH rules.

As a result of the Check 21 Act, a new bank treasury management product has been created that is known as “remote deposit.” In general, remote deposit allows a depositing customer the ability to capture the front and rear images of his/her check along with the respective magnetic ink character recognition (“MICR”) data of the check which typically includes the routing number of the financial institution issuing the check, the account number at the financial institution to which the check may be drawn from, and the check number of the check. This data may then be uploaded (by the depositing customer) to a depositing financial institution of the depositing customer, at which time the account of the depositing customer is then credited with the monetary amount listed on the check. With remote deposit, the old need for merchants and other large depositors to travel to the bank (or branch) to physically make a deposit is gone.

In addition to remote deposit, other electronic depositing services are now available through the ACH.

As a result of all of these electronic payment services, it is possible that a negotiable instrument (such as, for example, a check or an ACH withdrawal) may be generated that for a number of different reasons may not be honored by the financial institution associated with the account on which the negotiable instrument is drawn, i.e., the Payor bank. One reason might be that there are insufficient funds available in the account on which the negotiable instrument is attempting to be drawn. This is generally termed non-sufficient funds (“NSF”). Similarly, a situation where the funds deposited in the account have not yet cleared (i.e., making the funds unavailable) is generally termed uncollected funds (“UCF”). It is appreciated by those skilled in the art that whether the funds are NSF or UCF, unless specified as differently herein, the term NSF will be utilized for both instances. The reasons for the insufficient (i.e., inadequate) funds may because the account is overdrawn (i.e., an overdraft has occurred and money has been withdrawn from the account in an amount that has caused the available balance in the account to be less than zero) or because the amount listed on the negotiable instrument exceeds the available balance in the account even though that balance is an amount greater than zero but less than the amount listed on the negotiable instrument. Since checks, substitute checks, and ACH withdrawals are negotiable instruments that are not preauthorized withdrawals (such as ATM withdrawals and debit or check card withdrawals), the financial institution associated with the account may refuse to pay the negotiable instrument (in this example a non-preauthorized withdrawal request) and return the negotiable instrument as unpaid.

Unfortunately, even though the Payor's financial institution may refuse to honor a negotiable instrument if it is drawn against insufficient or unavailable funds, the reality is that if the bearer of the negotiable instrument (i.e., the Payee) does not physically come to the Payor's financial institutions to cash the negotiable instrument but, instead, deposits the check into his/her account (i.e., Payee account) at a different financial institution, then via overnight processing the Payor's financial institution may automatically pay/credit the amount listed on the negotiable instrument to Payee's account and then, only after Payor's financial institution performs a clearing process will Payor's financial institution learn that the negotiable instrument actually caused an NSF occurrence (also known as an NSF event).

On the Payor side of the equation, Payor's financial institution will generate an NSF notification and have to issue a Non-paid deposit notice (“NPD notice”). Once the Payee's financial institution receives the NPD notice the Payee's financial institution will have to repay the amount received less a charge for the risk. Further, the first financial institution (corresponding to the person generating the negotiable instrument—i.e., the Payor) will not honor the negotiable instrument and will send the Payor a NSF notification via first class mail and additionally charge the Payor a fee for generating a “bad” negotiable instrument.

On the Payee side of the equation, the Payee generally will be charged a fee from his/her financial intuition for the NSF instrument. Additionally, the Payee may have written negotiable instruments against the Payor's negotiable instrument thereby creating a snowball effect of bad instruments.

At this point, the Payee is left with the sole responsibility of collecting from the Payor the outstanding monetary amount listed on the negotiable instrument as well as any associated penalties, costs and fees. This may lead the Payee to bring legal action against the Payor. Moreover, the Payee's financial institution may also report the Payor to a database for bad check writers such as, for example, Check Connection, TeleCheck, Shared Check Authorization Network (“SCAN”) or ChexSystems. Finally, knowingly passing a “bad check” is a crime in most States with a range of criminal penalties.

Each business day every depositary financial institution generates a NSF list following reconciling accounts with the corresponding negotiable instruments (physical, ACH and electronic checks) received the previous business day. The list contains the NSF occurrence. Typically, for each NSF occurrence, the NSF list includes information about the corresponding account and the corresponding account holder. Traditionally, a manager of a given depositary financial institution would review the NSF list. In a very limited number of subjective situations, the manager had the discretion to have his/her financial institution pay a negotiable instrument (this is the exception traditionally linked to the manager knowing or having a special relationship with the Payor who wrote the negotiable instrument) to give that customer a chance to cover such an item. Typically this service was free and considered a benefit offered by some financial institutions to a very limited number of people. Unfortunately, this ad-hoc coverage was fully discretionary and the rare exception to the rule of returning the item unpaid.

In order to better understand the above discussed problem, the problem is illustrated in FIG. 1. In FIG. 1, a block diagram of an example of an implementation of a known way of paying with a negotiable instrument 100 between two people is shown. In this example, the first person is a Payor 102 and the second person is a Payee 104. The Payor 102 has a Payor account 106 at a first financial institution (“1^{st} FI”) 108 and the Payee 104 has a Payee account 110 at a second financial institution (“2^{nd} FI”) 112. In this example, the 1^{st} FI 108 and 2^{nd} FI 112 are in signal communication with each other over a signal path 114 which may include any known communication network 116. The communication network 116 may be a computer network such as, for example, the Internet, or a proprietary secure network. The signal path 114 between the 1^{st} FI 108 and 2^{nd} FI 112 may include a first computer server 118 (at the 1^{st} FI 108) and a second computer server 120 (at the 2^{nd} FI 112). It is appreciated that the Payor 102, Payee 104, or both, may be optionally business entities instead of individuals. Additionally, the Payor account 106, Payee account 110, or both, may be checking accounts. Moreover, it is appreciated that the communication network 116 may be in signal communication with a regional Federal Reserve Bank 117.

In an example of operation, the Payer 102 generates 122 the negotiable instrument 100 (such as, for example, a check, substitute check, or automated clearing house (“ACH”) payment) that lists a monetary amount 124 and passes 126 it to the Payee 104 either physically or electronically. In this example, the negotiable instrument 100 is drawn on the Payor account 106 such that the Payor 102 is a “Drawer” of the Payor account 106 and the 1^{st} FI 108 is a “Drawee” because the 1^{st} FI 108 is where the negotiable instrument 100 can be presented for payment from the Payor account 106. Once received by the Payee 104, the Payee 104 then deposits 128 the negotiable instrument 100 into the Payee account 110 either physically or utilizing remote deposit under the Check 21 Act. Once the negotiable instrument 100 is deposited into the Payee account 110, the 2^{nd} FI 112 may present 130 the negotiable instrument 100 (via for example, a substitute check) to the 1^{st} FI 108 for payment via the signal path 114 that includes the communication network 116. In response, the 1^{st} FI 108 sends a payment 132 for the monetary amount listed 124 on the negotiable instrument 100 via a computerized system (such as, for example, first computer server 118) utilizing the proper software. The 1^{st} FI 108 may utilize a Check 21 system or other interbank transaction system.

In this example, once the 1^{st} FI 108 has sent the payment 132 to the 2^{nd} FI 112, the 1^{st} FI 108 then withdraws the funds from the Payor account 106 and determines if there are sufficient funds available in the Payor account 106 to pay the listed monetary amount 124 of the negotiable instrument 100. If the funds are available in the Payor account 106, the listed monetary amount 124 of the negotiable instrument 100 is withdrawn from the Payor account 106 to satisfy the payment 132 made by the 1^{st} FI 108. If, instead, the 1^{st} FI 108 determines that there are insufficient funds in the Payor account 106 to pay the listed monetary amount 124 of the negotiable instrument 100, the clearing process designates the negotiable instrument 100 as causing an NSF occurrence and then places it as an NSF item on an NSF list that will be generated that day by the 1^{st} FI 108. In this example, the clearing process may be performed by a computer system such as, for example, a reconciliation system 134. The reconciliation system 134 may be optionally part of the first server 118 or another independent computer system of the 1^{st} FI 108. The reconciliation system 134 may include software that includes rules and decisions engines/modules to reconcile the amount paid on behalf of the Payor 102 with the funds available from the Payor account 106. The reconciliation system 134 has access to the 1^{st} FI 108 customer lists and corresponding accounts such that it may generate a daily NSF list 136 that includes all NSF occurrences with the corresponding negotiable instruments that caused the NSF occurrences, the corresponding accounts of the negotiable instruments, and the corresponding customer information of the accounts. This NSF list 136 may then be received and reviewed by a manager 138 of the 1^{st} FI 108.

In some exceptional cases, the manager 138 notices the Payor 102 is listed on the NSF list 136 as a result of negotiable instrument 100 causing an NSF occurrence and the manager 138 subjectively considers the Payor 102 an important or favorite customer of the 1^{st} FI 108. The manager 138, in some instances, may have the discretion to have the 1^{st} FI 108 pay the negotiable instrument 100 and because the negotiable instrument is then marked “pay,” an NSF notification 139 is not sent to the Payor 102 and the 2^{nd} FI 112 is not notified, with a NPD notice 140, that the negotiable instrument was not paid.

In another example, as another exceptional instance the manager 138, or other 1^{st} FI 108 representative, may notify 142 the Payor 102 of the need to cover the negotiable instrument 100 on the NSF list. In order to cover the instrument 100, the Payor must physically locate the manager (or his/her designee), pay cash and the manager (or his/her designee) must locate the NSF record in the 1^{st} FI's 108 system and manually mark the negotiable instrument 100 as “pay.”

If the Payor 102 does not deposit the funds 144 within the time allowed by the 1^{st} FI 108, the 1^{st} FI will notify the 2^{nd} FI 112 with a NPD notice 140 that the negotiable instrument 100 is not paid. Or in those cases when the 1^{st} FI 108 automatically paid the 2^{nd} FI 112 before reconciling the negotiable instruments, the 1^{st} FI 108 must demand repayment of the funds previously paid to the 2^{nd} FI 112 by the1^{st} FI 108 in relationship to the listed monetary amount 124 electronically paid for the negotiable instrument 100. The 2^{nd} FI 112 will return the payment 146 to the 1^{st} FI 108, usually, less a charge back or cost for the transaction. The 2^{nd} FI 112 may then optionally charge the Payee 104 a returned payment fee 148 which will be withdrawn from the Payee account 110. The Payee 104 is then again left to enforce the payment of the listed monetary amount owed by the Payor 102 by himself/herself. As stated above, this could result in possible undesirable legal, personal financial, personal reputation, and criminal issues for the Payor 102.

Attempts to solve these problems have included overdraft protection plans, linked account protection plans, and methods that notify the Payor of an overdraft condition with an associated time to cure the overdraft condition. Unfortunately, these attempted solutions do not always protect the Payor when an NSF occurs. Providing a means to reduce the cost of overdraft fees to a customer who has opted into an overdraft program is a distinct banking area wherein the customer is utilizing overdraft protection (i.e., a loan) to cover a debt. As an example, while overdraft protection plans typically can cover checks (up to an specific amount), ATM withdrawals, debit or check card withdrawals, electronic transfers, and the like, they usually require that the Payor is capable of financially qualifying for the plans, which are interest bearing loans from the financial institution. As such, the Payor may be denied qualifying for an overdraft protection plan if the credit rating or other financial situation of the Payor does not meet the minimums required by the financial institution. Similarly, the Payor may not be in financial situation where he/she is capable of having multiple accounts at the same financial institution that may be linked so as to be part of a linked account protection plan. Finally, there a numerous problems associated with known systems or methods that allow the Payor to cure an overdraft condition within a specified time period.

As an example, a system and method for allowing a Payor to cure an overdraft condition within a specified time period is described in U.S. Pat. No. 8,364,581, titled “SYSTEM AND METHOD FOR PROVIDING TIME TO CURE NEGATIVE BALANCES IN FINANCIAL ACCOUNTS WHILE ENCOURAGING RAPID CURING OF THOSE BALANCES TO A POSITIVE NET POSITION,” issued to Sthamer et al, Jan. 29, 2013, herein referred to as “the '581 patent” Generally, according to the '581 patent (in column 2, lines 47 to 60), a computer-implemented method is disclosed (with emphasis added)
for performing financial services comprising the step of determining an account balance for a financial account of a customer. If the account balance is negative, it is determined after a predetermined period of time and/or a predetermined end time or cut-off date or time, whether the negative balance of the financial account was cured. An overdraft fee is assessed to the financial account if the negative balance of the financial account was not cured during the predetermined period of time.
   The '581 patent (in column 3, lines 6 to 17) also discloses (with emphasis added)
a computer-implemented method for performing financial services comprising the step of determining an account balance for a financial account of a customer. If the account balance is negative, it is determined after a predetermined period of time and/or a predetermined end time or cut-off date or time, whether the negative balance of the financial account was cured. Any assessed overdraft fee for the negative balance is rebated to the financial account if the negative balance of the financial account was cured during the predetermined period of time. The predetermined period of time preferably extends at least until the next calendar day but can extend at least until the next business day.

Unfortunately, the '581 patent only describes a situation where the account of the Payor is overdrawn (i.e., described earlier as an overdraft). As such, the '581 patent describes a situation where the account of the Payor is utilizing an overdraft loan vehicle to cover a debt. As mentioned earlier, a negotiable instrument that is a non-preauthorized withdrawal (i.e. a check, substitute check, or ACH withdrawal) will not cause an overdraft because most financial institutions will not honor payment of these types of negotiable instruments when there are insufficient funds in the account associated with the negotiable instrument. As such, these types of negotiable instruments will not cause the account associated with the negotiable instrument to become negative as described in the '581 patent.

Specifically, the '581 patent describes situations whereby the account holder has opted into an overdraft protection plan and is not concerned with items returned non-paid as noted in the following discussion of the background section of the '581 patent (with emphasis added).
An overdraft occurs when a withdrawal from a bank or other financial institution account exceeds the available funds in the account. That is, the account has insufficient funds to cover the withdrawal. In the case of withdrawals such as checks or ACH withdrawals, the account provider can return the withdrawal request as unpaid. In the case of preauthorized withdrawals such as ATM withdrawals and debit or check card withdrawals, however, the account provider must pay the withdrawal request when presented, even if the withdrawal causes an overdraft. The account holder must then seek additional funds from the account holder to cover the overdraft and can charge the account holder overdraft fees as a penalty. (Column 1, lines 37 through 48)
Traditionally, the manager of a bank or other financial institution would look at a list of overdrafts each day. If the manager saw that a favored customer had incurred an overdraft, they had the discretion to pay the overdraft for the customer. Banks traditionally did not charge for this ad-hoc coverage but it was fully discretionary. This traditional ad-hoc coverage has practically disappeared. (Column 1, lines 49 through 55)
Account holders today can obtain overdraft protection plans. An overdraft protection plan is a contractual relationship in which the account provider promises to pay overdrafts up to a certain dollar limit. These overdraft lines of credit are typically loans and account holders typically charge a nominal fee per overdraft and also charge interest on the outstanding balance. Some account providers charge a small monthly fee regardless of whether the line of credit is used. Overdraft protection can cover checks, ATM Withdrawals, debit or check card withdrawals, electronic transfers, and the like. In the case of non-preauthorized items such as checks or ACH withdrawals, the overdraft protection allows for these withdrawals to be paid as opposed to being returned unpaid or “bouncing”. However, not all account holders qualify for such loans. (Column 1, line 56 through Column 2, line 3)

From this discussion, it is seen that the '581 patent recognizes that a NSF occurrence may occur that may cause an overdraft. However, generally an overdraft is a type of NSF occurrence but not all NSF occurrences are overdrafts because a NSF occurrence may occur when a withdrawal is attempted on an account that has insufficient funds to cover the withdrawal. Specifically, the '581 patent states that if this attempted withdrawal was the result of a check (also assumes a substitute check under the Check 21 Act) or ACH withdrawal, the type of withdrawal would be a non-preauthorized withdrawal (because it is not an ATM withdrawal, debit, or check card withdrawal) which “the account provider can return . . . as unpaid.” As such, the '581 patent specifically addresses the situation where the account holder (i.e., the Payor) has caused, either directly or indirectly, an overdraft on the account which shows up on a “list of overdrafts each day.” It does not, however, address the situation where an NSF occurrence is not an overdraft, which may be a larger problem than when the Payor causes an overdraft because checks, substitute checks, or ACH withdrawals may not be honored by the financial institution even though there are funds available in the associated account, which while being insufficient to pay the withdrawal request are still there and do not cause an overdraft.

An additional problem not addressed by the '581 patent is the form of payment that needs to be made by the Payor to “cure” the “negative balance of the financial account,” which is typically cash or cashier's check. Many times the Payor will not be able to make a payment that cures the overdraft, or cures an NSF occurrence, unless he/she physically goes to the financial institution. The reason for this is that financial institutions typically generate NSF lists and overdraft lists automatically via a computerized system (such as the reconciliation system 134 shown in FIG. 1) that must be reviewed by the manager. If, for example, the Payor deposits funds online or physically pays a teller at the financial institution, the deposited funds will be added to the account but unless the Payor locates a person with the authority to alter an NSF list and that authorized person identifies the NSF item corresponding to the Payor, the deposited funds will not be applied to the NSF or overdraft lists because they have already been run. Rather, those funds will simply be deposited to the account and increase its balance. As such, the Payor will still be listed as having an NSF occurrence and the associated negotiable instrument that caused the NSF occurrence will still be not honored and will be returned as having insufficient funds even though in, after the fact, the account was funded.

As such, there is a need for a system and method that improves the processing of NSF occurrences so as to address the above described problems. Additionally, there is a need for system and method that is capable of monitoring NSF occurrences to look for potential fraudulent activity.

### SUMMARY

A Dynamic Fraud Alert System (“DFAS”) for producing a fraud alert based on a received request to investigate (“RTI”) a potential customer, where the RTI is received from a requesting entity, and where the RTI includes potential customer information provided by the potential customer is described. The DFAS may include a DFAS database, comparator, and a decision module. The comparator is in signal communication with both the DFAS database and decision module. The DFAS database includes historical information from past RTIs and the comparator is configured to compare the potential customer information against the historical information from the DFAS database. The decision module determines whether there is an anomaly in the comparison of the potential customer information against the historical information from the DFAS database and, in response to the anomaly, produces a fraud alert.

As an example of operation, the DFAS performs a method for producing a fraud alert based on a received RTI a potential customer. The RTI is received from a requesting entity and the RTI includes potential customer information provided by the potential customer. The method may include receiving, from a DFAS database, historical information from past RTIs and comparing the potential customer information against the historical information from the DFAS database. The method may also include determining whether there is an anomaly in the comparison of the potential customer information against the historical information from the DFAS database and producing a fraud alert in response to determining that there is an anomaly in the comparison of the potential customer information against the historical information from the DFAS database.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a block diagram of an example of an implementation of a known way of paying with a negotiable instrument between two people.

FIG. 2 is a block diagram of an example of an implementation of a system for an improved way of paying with a negotiable instrument between two people and utilizing a Financial Alert Management System (“FAMS”) in accordance with the present invention.

FIG. 3 is a block diagram of an example of an implementation of a third-party FAMS that reduces the effects of an NSF occurrence caused by a negotiable instrument that is utilized by a Payor to pay a Payee in accordance with the present invention.

FIG. 4 is a table that includes an example of an implementation of tabular data regarding the NSF items and contact information for the Payors corresponding to the NSF items in accordance with the present invention.

FIG. 5 is a table that includes an example of an implementation of tabular data that includes contact information related to a customer shown in FIG. 4 in accordance with the invention.

FIG. 6 is a block diagram of an example of an implementation of the FAMS in signal communication with a plurality of FIs in accordance with the present invention.

FIG. 7 is a flowchart of an example of an implementation of a method for reducing the occurrence of a non-payment event (by a 1^{st} FI) of a negotiable instrument listing a monetary amount (where the negotiable instrument was generated by a Payor having a Payor account at the 1^{st} FI) with the FAMS described in FIGS. 2, 3, and 6 in accordance with the present invention.

FIG. 8 is a block diagram of an example of an implementation of a DFAS 800 in accordance with the present invention.

FIG. 9 is a flowchart of an example of an implementation of a method for receiving RTIs from customers of the DFAS and utilizing the information available to the DFAS to determine if there is any potential fraud in accordance with the present invention.

FIG. 10 is an illustration of a time line as a comparison of DFAS pro-active fraud watch to traditional methods and systems.

FIG. 11 is a flowchart of an example of an implementation of a method for monitoring NSF items (from different FIs against the same Payor) that are provided to the FAMS with the DFAS and utilizing the information available to the DFAS to determine if there is any potential fraud.

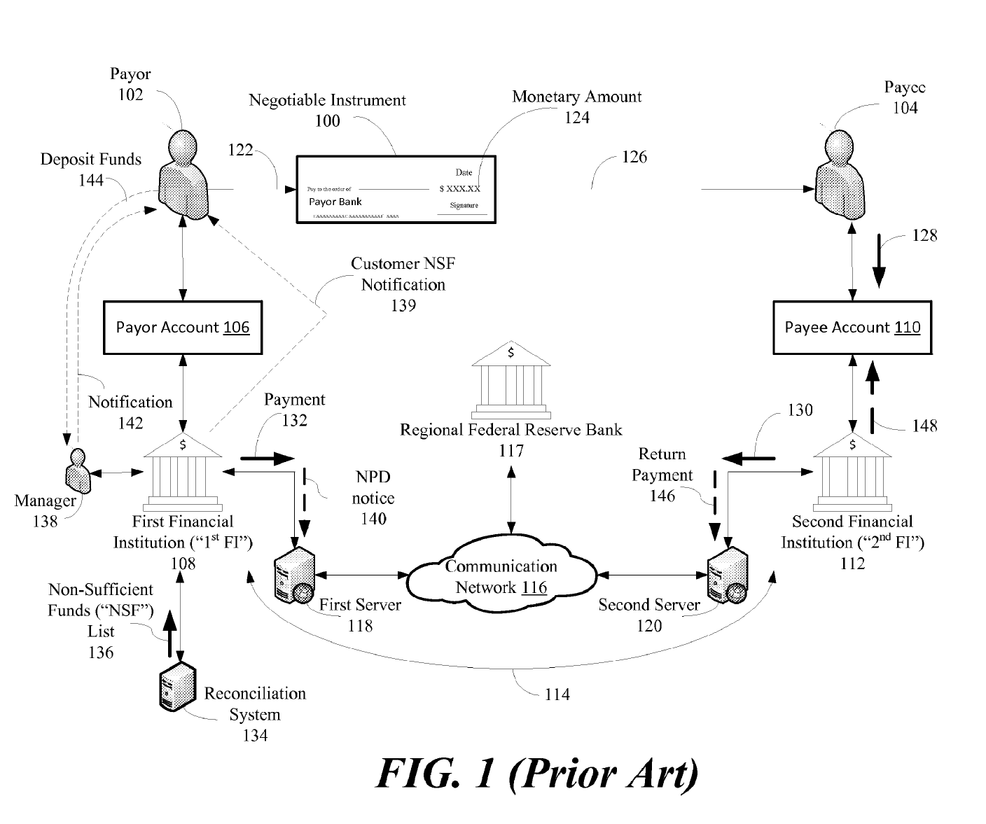

### DETAILED DESCRIPTION

A financial Alert Management System (“FAMS”) is described having a Financial Measure of Good Action Metric System (“MOGA”) in accordance with the present invention. The FAMS is a system that reduces the occurrence of a non-payment event where a first financial institution (“1^{st} FI”) refuses or declines to pay a negotiable instrument generated by a Payor having a Payor account at the 1^{st} FI, where the negotiable instrument has caused a non-sufficient funds (“NSF”) occurrence because the monetary amount of the negotiable instrument exceeds an available funds amount in the Payor account.

The FAMS may include a first communication module, a database, a timing module, a second communication module, a payment module, and a controller. The controller may be in signal communication with the first communication module, second communication module, payment module, timing module, and database. The controller is configured to control the operation of the FAMS. The first communication module is configured to receive an NSF list, Payor contact list, and a FI predetermined time period from the 1^{st} FI. The 1^{st} FI produces the NSF list that includes the NSF occurrence as an NSF item within the NSF list, the Payor contact list that includes contact information for Payor, and the FI predetermined time period for receiving funds to cover the NSF occurrence before the 1^{st} FI refuses to pay the negotiable instrument. The database is configured to store the NSF items from the NSF list and the contact information for the Payor from the Payor contact list and the timing module is configured to generate a FAMS predetermined time period based on the FI predetermined time period. The second communication module is configured to attempt communication with the Payor based on the contact information for the Payor and, if successful, communicate to the Payor the NSF occurrence, the need to pay at least the amount necessary to cure the NSF occurrence, and the FAMS predetermined time period and the payment module is configured to receive a payment from the Payor. The first communication module is further configured to send a payment notice to the 1^{st} FI such that the 1^{st} FI does not refuse to pay the negotiable instrument.

As an example of operation, the FAMS performs a method that reduces the occurrence of a non-payment event where the 1^{st} FI refuses to pay the negotiable instrument generated by the Payor, where the negotiable instrument has caused a NSF occurrence because the monetary amount of the negotiable instrument exceeds the available funds amount in the Payor account. The method includes receiving the NSF list, Payor contact list, and FI predetermined time period from the 1^{st} FI, storing the NSF items from the NSF list and storing the contact information for the Payor from the Payor contact list, generating a FAMS predetermined time period based on the FI predetermined time period, and attempting communication with the Payor based on the contact information for the Payor. If the attempted communication is successful, the method may also include communicating to the Payor the NSF occurrence, the need to pay at least the amount necessary to cure the NSF occurrence, and the FAMS predetermined time period to receive the payment. The method also includes receiving a payment from the Payor within the predetermined time period and sending a payment notice to the 1^{st} FI such that the 1^{st} FI does not refuse to pay the negotiable instrument.

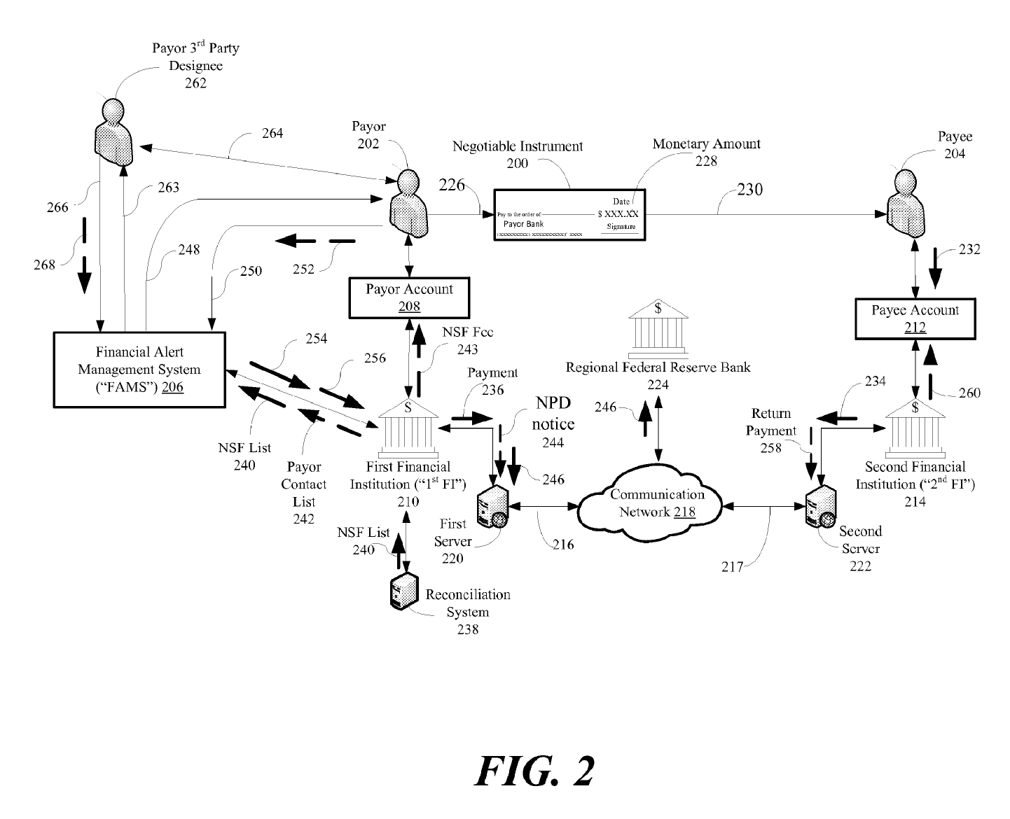

In FIG. 2, a block diagram of an example of an implementation of a system for an improved way of paying with a negotiable instrument 200 between two people 202 and 204 utilizing a Financial Alert Management System (“FAMS”) 206 is shown. In this example, the first person 202 is a Payor and the second person 204 is a Payee. The Payor 202 has a Payor account 208 at a first financial institution (“1^{st} FI”) 210 and the Payee 204 has a Payee account 212 at a second financial institution (“2^{nd} FI”) 214. In this example, the 1^{st} FI 210 and 2^{nd} 214 are in signal communication with each through the combination of signal paths (216 and 217) and any known communication network 218. The communication network 218 may be a computer network such as, for example, the Internet, or a proprietary secure network. The signal paths 216 and 217 between the 1^{st} FI 210 and 2^{nd} FI 214 may include a first computer server 220 (at the 1^{st} FI 210) and a second computer server 222 (at the 2^{nd} FI 214). It is appreciated that the Payor 202, Payee 204, or both, may be optionally business entities instead of individuals. Additionally, the Payor account 208, Payee account 212, or both, may be, for example, checking accounts. Moreover, it is appreciated that the communication network 218 may be in signal communication with a regional Federal Reserve Bank 224.

It is appreciated by those skilled in the art that some of the circuits, components, modules, and/or devices of the system disclosed in the present application are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying analog and/or digital formats without passing through a direct electromagnetic connection. These information paths may also include analog-to-digital conversions (“ADC”), digital-to-analog (“DAC”) conversions, data transformations such as, for example, fast Fourier transforms (“FFTs”), time-to-frequency conversations, frequency-to-time conversions, database mapping, signal processing steps, coding, modulations, demodulations, etc.

In an example of operation, the Payer 202 generates 226 the negotiable instrument 200 (such as, for example, a check, substitute check, or automated clearing house (“ACH”) payment) that lists a monetary amount 228 and passes 230 it to the Payee 204 either physically or electronically. In this example, the negotiable instrument 200 is drawn on the Payor account 208 such that the Payor 202 is a “Drawer” of the Payor account 208 and the 1^{st} FI 210 is a “Drawee” because the 1^{st} FI 210 is where the negotiable instrument 200 can be presented for payment from the Payor account 208. Once received by the Payee 204, the Payee 204 then deposits 232 the negotiable instrument 200 into the Payee account 212 either physically or utilizing remote deposit under the Check 21 Act. Once the negotiable instrument 200 is deposited into the Payee account 212, the 2^{nd} FI 214 may present 234 the negotiable instrument 200 (via for example, a substitute check) to the 1^{st} FI 210 for payment via the signal path 216 that includes the communication network 218. In response, the 1^{st} FI 210 sends a payment 236 for the monetary amount listed 228 on the negotiable instrument 200 via a computerized system (such as, for example, first computer server 220) utilizing the proper software. The 1^{st} FI 210 may utilize a Check21 compliant system, an account (not shown) at the regional Federal Reserve Bank 224, or other interbank transaction system.

In this example, once the 1^{st} FI 210 has sent the payment 236 to the 2^{nd} FI 214, the 1^{st} FI 210 then acts to withdraw (i.e., begins a procedure to withdraw but does not actually withdraw) the funds from the Payor account 208 and determines if there are sufficient funds available in the Payor account 208 to pay the listed monetary amount 228 of the negotiable instrument 200 utilizing a reconciliation process. If the funds are available in the Payor account 208, the listed monetary amount 228 of the negotiable instrument 200 is withdrawn from the Payor account 208 to satisfy the payment 236 made by the 1^{st} FI 210. If, instead, the 1^{st} FI 210 determines that there are insufficient funds in the Payor account 208 to pay the listed monetary amount 228 of the negotiable instrument 200, the clearing process designates the negotiable instrument 200 as causing an NSF occurrence (also known as an NSF event) for the Payor account 208 and then places it as an NSF item on an NSF list that will be generated that day by the 1^{st} FI 210. In this example, the clearing process may be performed by a computer system such as, for example, a reconciliation system 238. The reconciliation system 238 may be optionally part of the first server 220 or another independent computer system of the 1^{st} FI 210. The reconciliation system 238 may include software that includes rules and decision engines/modules to perform the reconciliation process that reconciles the amount paid on behalf of the Payor 202 with the funds available from the Payor account 208. The reconciliation system 238 has access to the 1^{st} FI 210 customer lists and corresponding accounts such that it may generate a daily NSF list 240 that includes all NSF occurrences with the corresponding negotiable instruments that caused the NSF occurrences, the corresponding accounts of the negotiable instruments, and the corresponding customer information of the accounts. This NSF list 240 is then sent to the FAMS 206. A Payor contact list 242 of the contact information for corresponding Payors that caused the NSF items of the NSF list 240 may also be sent to the FAMS 206. It is appreciated that the Payor contact list 242 may not be sent if all relevant customer contact information is already provided in the NSF list 240. Additionally, if the FAMS 206 is part of the 1^{st} FI 210, there may not be a need to send the Payor contact list 242 because the information is already available to the FAMS 206 through access to other databases (not shown) within systems located or controlled by the 1^{st} FI 210. At this point, the 1^{st} FI 210 may generate an optional NSF fee 243 that may be charged against the Payor account 208 for the specific NSF occurrence.

In this example, the Payor contact information in the Payor contact list 242 may include, for example, the account number corresponding to the NSF item, Payor's name, Payor's home, work, and/or mobile telephone numbers, Payor's work and/or personal emails, mobile text number, social security number, date of birth, home and/or business address, third-party contact information (i.e., a “3^{rd} party designee” such as, for example, contact information for a spouse, parent, offspring, sibling, friend, business colleague or associate, etc.), and Payor's personal preferences. In this example, FAMS 206 may be a system that is either a part of 1^{st} FI 210 or a third-party system that is controlled and operated by an independent organization (i.e., a “FAMS organization”) that is associated with the 1^{st} FI 210. If FAMS 206 is a third-party system, the FAMS organization may have a contractual relationship with the 1^{st} FI 210. Additionally, the FAMS organization may also have contractual relationships with individual customers which may include Payor 202. In the case of the FAMS organization having contractual relationships with individual customers such as, for example, Payor 202, the FAMS 206, as described below, allows an extra-level of protection for the Payor 202 to deal with a potential NSF occurrence.

Once the NSF list 240 is provided to FAMS 206, the 1^{st} FI 210 will pause sending any Non-paid deposit notices (“NPD notices”) 244 to the 2^{nd} FI 214, where each NPD notice 244 corresponds to an NSF item on the NSF list 240 (including the NSF item corresponding to the NSF occurrence caused by the negotiable instrument 200). In general, a NPD notice is a notification from the 1^{st} FI 210 to the 2^{nd} FI 214 that a request for the return of a deposited item. Specifically in this example, the NSF occurrence of was caused by the negotiable instrument 200 will be listed as an NSF item on the NSF list 240, which is passed to the FAMS 206, and then the 1^{st} FI 210 will pause the sending of a NPD notice 244 to the 2^{nd} FI 214 (which corresponds to the NSF occurrence caused by the negotiable instrument 200) for a 1^{st} FI predetermined time period. In the example of a third-party FAMS organization, the pausing of sending the NPD notice 244 may be partly based on the contractual conditions agreed to by the FAMS organization and a plurality of FIs that include both the 1^{st} FI 210 and 2^{nd} FI 214. Alternatively, in case of the FAMS 206 being a system controlled and operated by the 1^{st} FI 210, the FAMS 206 itself may pause the sending of the NPD notice 244 for the 1^{st} FI predetermined time period. The 1^{st} FI predetermined time period is generally the time from which the NSF occurrence was identified by the 1^{st} FI 210 to the 1^{st} FI cut-off time to reconcile the accounts at the 1^{st} FI 210 at which time financial reconciliation information 246 needs to be sent from the 1^{st} FI 210 to one of regional Federal Reserve Banks 224 unless the 1^{st} FI 210 utilizes a difference reconciliation process that is based on a contractual settlement process between the plurality of FIs (which includes both 1^{st} FI 210 and 2^{nd} FI 214) that does not utilize the regional Federal Reserve Bank 224. This 1^{st} FI cut-off time may vary based on the time zone of the corresponding Regional Federal Reserve Bank 224 with which the 1^{st} FI 210 has an account, such that the 1^{st} FI predetermined time period may be less for a Payor located on the west coast that is utilizing a FI located on the east coast of the U.S. versus an FI located on the west coast.

If FAMS 206 is a third-party system, once the FAMS 206 receives the NSF list 240 and the Payor contact list 242, the FAMS 206 attempts to contact 248 the Payor 202 via one or more electronic contact methods based on the contract information provided for the Payor 202. This may include, for example, robo-calling the Payor's home, work with either pre-recorded or computer generated voice messages, and/or mobile telephone numbers, generating a computer message that can be utilized by a call center person to call and potentially talk to the Payor, sending computer generated text messages to Payor's mobile, sending computer generated emails to the Payor's personal and/or work emails. If contact 248 with the Payor 202 is established (i.e., someone picked up the phone when called by the FAMS 206, FAMS 206 was able to leave a voicemail on one of the listed telephone numbers, or FAMS 206 texts and/or emails were sent without bouncing back) by the FAMS 206, the FAMS 206 may be configured to note the time that contact was made in its database (not shown) and it may keep track of the time left to for the Payor 202 to respond before a FAMS predetermined time period runs out or a FAMS additional or repeat contact may be made. The FAMS 206 will then communicate in all its communications with the Payor 202 the FAMS predetermined time period to respond to the Payor 202. The FAMS predetermined time period may be equal to or less than the 1^{st} FI predetermined time period. If the Payor 202 responds 250 to the FAMS 206 within the predetermined time period, the FAMS 206 will attempt to negotiate a way of avoiding the NPD notice 244 being sent to the 2^{nd} FI 214. This negotiation involves receiving a payment 252 from the Payor 202 that will cover the NSF occurrence caused by the negotiable instrument 200 before the expiration of the FAMS predetermined time period.

This payment 252 will include at least the necessary amount of funds to cover the insufficient amount resulting from the monetary amount 228 of the negotiable instrument 200 being applied against the available funds in the Payor account 208. The payment 252 may also include a FAMS 206 proceeding fee, NSF fee 243, and other fees. The payment 252 is optional in that making the payment 252 is at the discretion of the Payor 202. If the payment 252 is made within the FAMS predetermined time period, then the FAMS 206 receives the payment 252, optionally deducts the FAMS 206 processing fee, and sends the remaining funds 254 to the 1^{st} FI 210. The funds 254 are received by the 1^{st} FI 210, applied to the Payor account 208 to reconcile one or more of the negotiable instruments that caused the NSF occurrence in the account, and, as such, the 1^{st} FI 210 does not send the NPD notice 244 (corresponding to the NSF occurrence caused by the negotiable instrument 200) to the 2^{nd} FI 214. In this example, as long as the Payor 202 makes a payment 252 to the FAMS 206 before the expiration of the FAMS predetermined time period, the 1^{st} FI 210 will either pay the 2^{nd} FI 214 (if a prior pre-reconciliation payment 236 was not paid), or not send the NPD notice 244 if the payment 236 had been made. It is appreciated that the FAMS predetermined time period communicated to the Payor 202 is either less than the FI predetermined time period because the FAMS predetermined time period takes into account the time lag in receiving the payment 252 from the Payor 202 and the actual FI predetermined time period or because the FAMS organization has a contractual agreement with the 1^{st} FI 210 that if the FAMS 206 receives the payment 252 within the FI predetermined time period, it will guarantee payment to the 1^{st} FI 210 with the funds 254. This disclosure also includes segregating Payors into groups which have been defined by attributes or criteria including but not limited to different pre-determined time periods. Such criteria may be related to FI or FAMS historical dealings with Payor, contractual agreement with Payor, estimate of credit worthiness of the Payor and the like.

In this case, since the FAMS organization is an independent entity from the 1^{st} FI 210, the FAMS organization may choose to allow the FAMS 206 to accept non-cash payments or even cash payments at non-1^{st} FI 210 locations from the Payor 202. As an example, the FAMS 206 may accept cash payments at branches or automated teller machines (“ATMs”) of other FAMS organization member FIs and may optionally charge an additional fee that may include a FAMS deposit fee and a receiving FI's deposit fee. Additionally, the FAMS 206 may accept payments from accounts at other FIs, wire transfer, ACH transactions, cashier's checks, one or more credit card payments, one or more gift card payments, one or more prepaid credit cards, one or more prepaid gift cards, one or more debit cards, PayPal® payments, money orders, foreign currency, MoneyGram® from Western Union® payments, credit line, home equity line, bit coin, digital currency or combination of these. Moreover, the FAMS 206 may allow the Payor 202 to apply, get approved, and be provided with a financial loan that will cover at least the funds needed for the payment 252. The financial loan may be based on the credit worthiness of the Payor 202.

In the case that the Payor 202 does not contact 250 the FAMS 206 within the FAMS predetermined time period or does contact the FAMS 206 but does not either agree to make the necessary payment 252 or makes the payment 252 past the expiration of the FAMS predetermined time period, the FAMS 206 either notifies 256 the 1^{st} FI 210 that payment has not been made or simply does not make the funds payment 254 to the 1^{st} FI 210 within the FI predetermined time period. As such, at the expiration of the FI predetermined time period the 1^{st} FI will notify 210 the 2^{nd} FI 214 that the negotiable instrument 200 is not paid. Or in those cases when the 1^{st} FI 210 automatically paid the 2^{nd} FI 214 before reconciling the negotiable instruments, the 1^{st} FI 210 will send the NPD notice 244 to the 2^{nd} FI 214 demanding repayment of the earlier payment 236 made to the 2^{nd} FI 214 in relation to the listed monetary amount 228 electronically paid for the negotiable instrument 200. The 2^{nd} FI 214 will return the payment 258 to the 1^{st} FI 210 less a charge back or cost for the transaction. The 2^{nd} FI 214 may then optionally charge the Payee 204 a returned payment fee 260 which will be withdrawn from the Payee account 212. The Payee 204 is then left to enforce the payment of the listed monetary amount 228 owed by the Payor 202 by himself/herself. As stated above, this could result in possible undesirable legal, personal financial, personal reputation, and criminal issues for the Payor 202.

Additionally, if contact information is available for a 3^{rd} party designee 262, the FAMS 206 may try to contact 263 the Payor's 3^{rd} party designee 262 based on the information provided by the 1^{st} FI 210 (in the Payor contact list 242) or a customer database (not shown) of the FAMS 206 if the Payor 202 is a customer of the FAMS organization. Once the 3^{rd} party designee 262 is contacted, the FAMS 206 may instruct the 3^{rd} party designee 262 to contact 264 the Payor 202 so that the Payor 202 may respond to the request within the FAMS predetermined time period and/or allow the 3^{rd} party designee 262 to respond 266 directly to the FAMS 206 for payment arrangements. If the Payor 202 responds 250 to the FAMS 206 in response to the FAMS 206 contacting 264 the 3^{rd} party designee, the process proceeds as described earlier. If, on the other hand, the 3^{rd} party designee 262 responds 266 to the FAMS 206, the FAMS 206 may allow the 3^{rd} party designee 262 to make the same type of payment 268 arrangements as described above in relation to the Payor 202. In this case, if the 3^{rd} party designee makes a payment 268 (similar to payment 252 made by the Payor 202) within the FAMS predetermined time period, the 1^{st} FI 210 will not send the NPD notice 244 to the 2^{nd} FI 214.

Specifically, the payment 268 is again optional in that making the payment 268 is at the discretion of the 3^{rd} party designee 262. Similar to payment 252, the payment 268 will include at least the necessary amount of funds to cover the insufficient amount resulting from the monetary amount 228 of the negotiable instrument 200 being applied against the available funds in the Payor account 208. The payment 268 may also include a FAMS 206 proceeding fee, the NSF fee 243, and other fees. If the payment 268 is made within the FAMS predetermined time period, then the FAMS 206 receives the payment 268, optionally deducts the FAMS 206 processing fee, and sends the remaining funds 254 to the 1^{st} FI 210. The funds 254 are received by the 1^{st} FI 210, applied to the Payor account 208 to reconcile one or more of the negotiable instruments that caused the NSF occurrence in the account, and, as such, the 1^{st} FI 210 does not send the NPD notice 244 (corresponding to the NSF occurrence caused by the negotiable instrument 200) to the 2^{nd} FI 214. In this example, as long as the 3^{rd} party designee 262 makes a payment 268 to the FAMS 206 before the expiration of the FAMS predetermined time period, the 1^{st} FI 210 will either pay 236 the 2^{nd} FI 214 (if a prior pre-reconciliation payment 236 has not been made) or not send the NPD notice 244. Again, it is appreciated that the FAMS predetermined time period communicated to the 3^{rd} party designee 262 is either less than the FI predetermined time period because the FAMS predetermined time period takes into account the time lag in receiving the payment 268 from the 3^{rd} party designee 262 and the actual FI predetermined time period or because the FAMS organization has a contractual agreement with the 1^{st} FI 210 that if the FAMS 206 receives the payment 268 within the FI predetermined time period, it will guarantee payment to the 1^{st} FI 210 with the funds 254.

It is appreciated, that the FAMS 206 may allow for a combination of payment 250 and 268 from both the Payor 202 and 3^{rd} party designee 262.

Again, in this case, since the FAMS organization is an independent entity from the 1^{st} FI 210, the FAMS organization may choose to allow the FAMS 206 to accept non-cash payments or even cash payments at non-1^{st} FI 210 locations from the 3^{rd} party designee 262. As an example, the FAMS 206 may accept cash payments at branches or ATMs of other FAMS organization member FIs and may optionally charge an additional fee that may include a FAMS deposit fee and a receiving FI's deposit fee. Additionally, the FAMS 206 may accept payments from accounts at other FIs, wire transfer, ACH transactions, cashier's checks, one or more credit card payments, one or more gift card payments, one or more prepaid credit cards, one or more prepaid gift cards, one or more debit cards, PayPal® payments, money orders, foreign currency, MoneyGram® from Western Union® payments, credit line, home equity line, bit coin, digital currency or combinations of these. Moreover, the FAMS 206 may allow the 3^{rd} party designee 262 to apply, get approved, and be provided with a financial loan that will cover at least the funds needed for the payment 252. The financial loan may be based on the credit worthiness of the 3^{rd} party designee 262.

In this example, the FAMS 206 may generate a unique identifier code (“FAMS UIC”) to uniquely identify the NSF item (or items) corresponding to the Payor. The FAMS 206 may generate a plurality of FAMS UICs that are stored in a database (not shown) corresponding to different NSF items. By utilizing the plurality of FAMS UICs, corresponding FI that associated with the FAMS organization may utilize the FAMS UICs to identify a NSF item and the corresponding Payor. As such, in this example, the Payor 202 or 3^{rd} party designee 262 may go to another FI (such as, for example, 2^{nd} FI 214) to make a payment 252 or 268. Once at the other FI, the Payor 202 or 3^{rd} party designee 262 may present the FAMS UIC to a FI teller (or enter it in an automated payments station such as, for example an ATM) and the FI teller or automatic payment station will recognize the FAMS UIC and allow the payments 250, 268, or combination of both, to be made. In this example, the other FI may charge a FAMS convenience fee to the Payor 202 or 3^{rd} party designee 262. Similarly, with the FAMS UIC, the FAMS 206 may allow the Payor 202 or 3^{rd} party designee 262 to pay via a telephone call center, online via an Internet website, and via a mobile application.

In addition to FAMS UIC, the FAMS 206 may utilize coded messages to allow the Payor 202 to keep his/her privacy. These communications may be coded via safe word, alpha numeric code, or other private type of communication.

If the FAMS 206 is a system within the 1^{st} FI 210, the operation is basically the same as described above, except that the NSF list 240 and Payor contact list 242 is information that is internally (i.e., within the 1^{st} FI 210) accessed by the FAMS 206. Additionally, since the FAMS 206 is part of the 1^{st} FI 210, the FAMS predetermined time period and FI predetermined time period is the same. Moreover, since the FAMS 206 is part of the 1^{st} FI 210, the FAMS 206 does not need to send funds 254 to the 1^{st} FI 210 and notification 256 that a payment has not been made would be replaced by an internal confirmation that the payment, rather than be deposited in the Payor's account, was to be applied to remove the already processed NSF item from the NSF list. In this example, the payment 252 or 268 for the Payor 202 or 3^{rd} party designee 262 would be made directly to the 1^{st} FI 210.

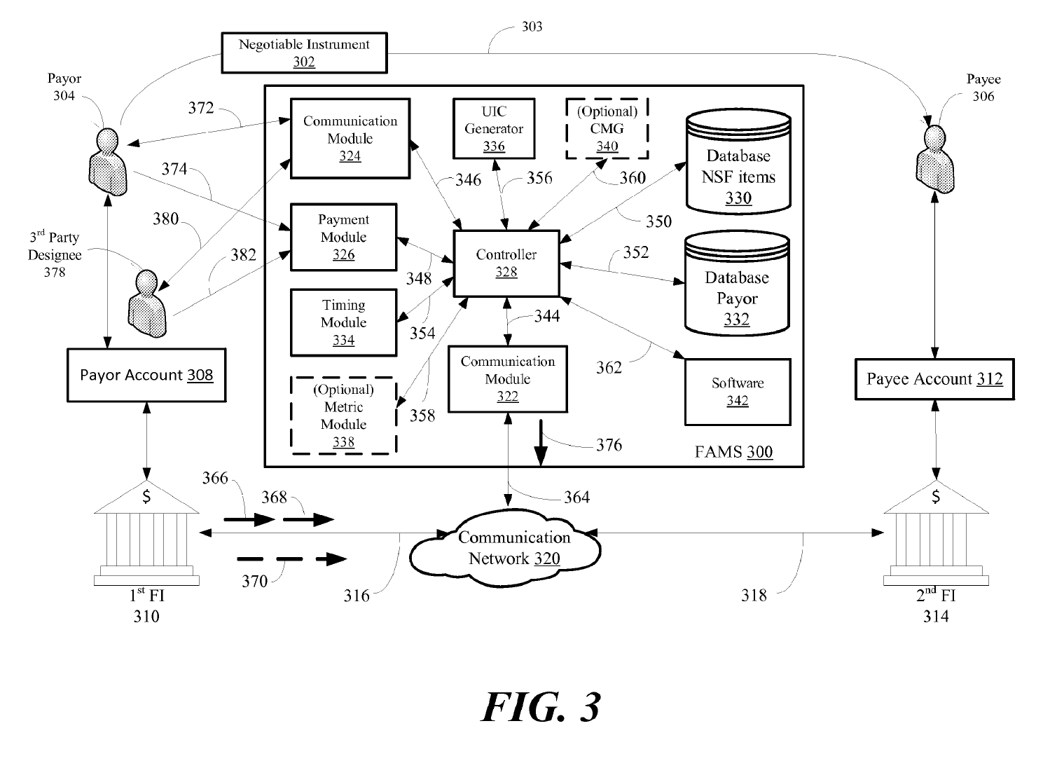

In FIG. 3, a block diagram of an example of an implementation of a third-party FAMS 300 that reduces the effects of an NSF occurrence caused by a negotiable instrument 302 that is utilized by a Payor 304 to pay 303 a Payee 306 is shown. As described earlier, the Payor 304 may have a Payor account 308 at a 1^{st} FI 310 and the Payee 306 may have a Payee account 312 at a 2^{nd} FI 314. Again, the 1^{st} FI 310 and 2^{nd} FI 314 may be in signal communication via a signal paths 316, 318, and communication network 320 that may be, for example, the Internet. The FAMS 300 may include a first communication module 322, second communication module 324, payment module 326, controller 328, database of NSF items 330, database of Payors 332, timing module 334, UIC generator 336, optional metric module 338, and software module 342. In this example, the controller 328 may be in signal communication with first communication module 322, second communication module 324, payment module 326, database of NSF items 330, database of Payors 332, timing module 334, UIC generator 336, optional metric module 338, optional coded message generator (“CMG”) 340, and software module 342 via signal paths 344, 346, 348, 350, 352, 354, 356, 358, 360, and 362, respectively. In this example, the FAMS 300 may be integrated into a single signal computer system or, alternatively, may be integrated over multiple computer systems. The FAMS 300 may be in signal communication with the 1^{st} FI 310 via signal paths (316 and 364) and communication network 320. Similarly, the FAMS 300 may also be in signal communication with the 2^{nd} FI 314 via signal paths (318 and 364) and communication network 320.

Based on the description in FIG. 2, in FIG. 3 an example of operation of the FAMS 300 starts when the FAMS 300 receives an NSF list 366 and Payor contact list 368 from the 1^{st} FI 310 at the first communication module 322. If the negotiable instrument 302 has caused an NSF occurrence, the negotiable instrument 302 will be listed as an NSF item of the NSF list 366. Additionally, the Payor's account information, contact information, and possible personal information is passed to the FAMS 300 via a Payor contact list 368. This information is received by the first communication module 322 and passed to the database of NSF items 330 and database of Payors 332, respectively. The controller 328 and UIC generator 336 may generate UICs for the NSF items of the NSF list 366 and the Payors information on the Payor contact list 368 utilizing the database of NSF items 330 and database of Payors 332. The UICs may be utilized by the FAMS 300 as a customer and payment identification number. As an example, a UIC may be utilized as a temporary payment routing number that allows reception of payments by or on behalf of Payor 304 to Payor account 308. The UIC may be, as an example, an alpha numeric code that uniquely identifies the Payor within the FAMS 300 and at FI that are associated with the FAMS organization. The controller 328 and timing module 334 may then determine a FAMS predetermined time period based on the information provided in the NSF list 366 which includes the time that NSF items were identified by the 1^{st} FI 310 and the possibly the FI predetermined time period that the 1^{st} FI 310 has until it needs to send NPD notice 370 to the 2^{nd} FI 314 and/or regional Federal Reserve Bank (not shown). The controller 328 and a message module (not show) may generate a voice pre-recorded or machine generated message to send via telephone or a textual message to send via textual communications means such as, for example, email, mobile text messaging, or social media based text messaging. The message may be explicit such as, for example, “You need to contact Bank ‘A’ regarding reference number XXXX.” In the case that the Payor 304 is a customer of the FAMS organization, the message may be even more explicit such as, for example, “You need to contact Bank ‘A’ regarding X number of NSF items, please use reference number XXXX.” Alternatively, the controller 328 and optional CMG 340 may then optionally generate a coded message to send to the Payor 304 in instances when privacy is required such that less explicit communications and/or codes may be utilized. These coded communications may be coded via a safe word or password. The controller 328 and second communication module 324, in combination with the database of Payors 332 may then attempt to contact 372 the Payor 304 via the different forms of contact provided the Payor contact list 368 or Payor 304 provided contact information if the Payor 304 is a customer of the FAMS organization. The second communication module 324 may time stamp each communication attempt with the Payor 304 and store that time stamp in the database of NSF items 330, database of Payors 332, other database (not shown), or combination of one or more of these. The time stamp may include the data and time that the attempted communication was made. The FAMS 300 may also record in one of the databases that time stamp, form of communication attempted, and whether the attempt was successful in reaching the Payor 304—i.e., a voicemail was left on the cellphone of the Payor, the Payor 304 received the call and possibly gave confirmation of receiving the call, and an email and/or text message was successfully sent. In these examples, each successful form of communication send to the Payor 304 includes also communicating the FAMS predetermined time period and the need for the Payor 304 to respond to the FAMS 300 before the expiration of the FAMS predetermined time period. If the Payor 304 responds to the FAMS 300 before the expiration of the FAMS predetermined time period, the FAMS 300 will inform the Payor 304 what the possible options are to correct the situation. The FAMS 300 will communicate to the Payor 304 what the required payment 374 is, how it can be paid, and what the time limit to pay based on the FAMS predetermined time period. The payment module 326 is a device, devices, subsystem, or software/hardware module that is capable of receiving the payment 374 from the Payor 304. Examples of the payment module 326 may include a website interface, software and hardware required to allow reception of payment 374 at other FI, at ATMs, via electronic funds transfers systems, etc. Once a payment 374 is received by the payment module 326 within the FAMS predetermined time period, the payment module 326 (either by itself or in combination with other FAMS 300 subsystems) may send funds 376 to the 1^{st} FI 310 within the FI predetermined time period. The payment module 326 by itself, or in combination with other FAMS 300 subsystems (such as, for example, the timing module 334), may time stamp the date and time of reception of the payment 374 from the Payor 304. This information may then be saved into one of the databases in the FAMS 300. The optional metric module 338 may then evaluate how the Payor 304 responds to NSF occurrences and, as a result, assign a quality score based on the historic performance of Payor 304 in responding the NSF occurrences caused by the Payor 304.

If the FAMS 300 is unsuccessful in reaching the Payor 304 or if the Payor 304 designates a 3^{rd} party designee 378, the FAMS 300 will attempt to contact 380 the 3^{rd} party designee 378. The FAMS 300 may utilize the same process (described earlier) in contacting 380 the 3^{rd} party designee 378 as was utilized in attempting to contact 372 the Payor 304. However, the messages will typically be different because the messages may attempt to reach the Payor 304 through the 3^{rd} party designee 378 and possibly allow the 3^{rd} party designee 378 to make a payment 382 to the FAMS 300 for the Payor 304. In this variation, the controller 328 and a message module (not show) may generate a voice pre-recorded or machine generated message to send via telephone or a textual message to send via textual communications means such as, for example, email, mobile text messaging, or social media based text messaging. The message may be explicit such as, for example, “Please let [Payor] know that he/she needs to contact Bank ‘A’ regarding reference number XXXX.” In the case that the Payor is a customer of the FAMS organization, the message may be even more explicit such as, for example, “Please let [Payor] that they need to contact Bank ‘A’ regarding X number of NSF items, please use reference number XXXX.” Alternatively, the controller 328 and optional CMG 340 may then optionally generate a coded message to send to the 3^{rd} Party designee 378 in instances when privacy is required such that less explicit communications and/or codes may be utilized. This coded message may be different than the coded message that would be generated for the Payor 304 had the FAMS 300 contacted 372 the Payor 304 directly. As mentioned earlier, the message to the 3^{rd} Party designee 378 may also include information allowing the 3^{rd} party designee 378 to make the payment 382 for the Payor 304. In this example, the message to the 3^{rd} party designee 378 may be, for example, “Hello [3^{rd} party designee] we are contacting you in an attempt to reach [Payor] regarding the need to contact Bank ‘A’ regarding an urgent issue. If you would like to contact Bank ‘A’ for [Payor], please use reference number XXXX.”

In this example, the payment module 326, timing module 334, UIC generator 336, optional metric module, and optional CMG may be modules and/or devices that are implemented in hardware, software, or combinations of both. Each of these modules may be software modules that run on a processor (such as, for example, controller 328 or other processor that is not shown) which may include a central processing unit (“CPU”), digital signal processor (“DSP”), application specific integrated circuit (“ASIC”), field programmable gate array (“FPGA”), microprocessor, etc. Alternatively, each module may also be or include hardware devices such as logic circuitry, a CPU, a DSP, ASIC, FPGA, etc. The first communication module 322 and second communication module 324 may include hardware and software capable of receiving and sending information to the communication network 320 (such as, for example, Ethernet circuitry) and other communication hardware and software capable of accessing the Internet, email, the cellular telephone network, the landline telephone network, PCS services, mobile text services, etc. The database of NSF items 330 is a FAMS 300 database capable of storing all the NSF items received by the FAMS 300 from the associated FIs through the NSF list 366 or through another sharing of customer information. The database of Payors 332 is another FAMS 300 database capable of storing all the customer information related to the Payors that may either be received from the associated FIs (through the NSF list 366, Payor contract list 368, or combination of both) or from the individual customers (that may include Payor 304) themselves. The FAMS 300 may also include other databases and storage devices (such as random access memory (“RAM”) modules), which are not shown, that allow the processing of the data within the database of NSF items 330 and database of Payors 332. The controller 328 may be any type of processor capable of controlling the functions and operation of the modules the FAMS 300. It is appreciated that the controller 328 may actually be multiple controllers acting in coordination to control the operation of the FAMS 300. The software module 342 may be a storage device, or devices, that stores the software needed to run the controller 328 or other FAMS 300 modules 322, 324, 326, 330, 332, 334, 336, 338, and/or 340.

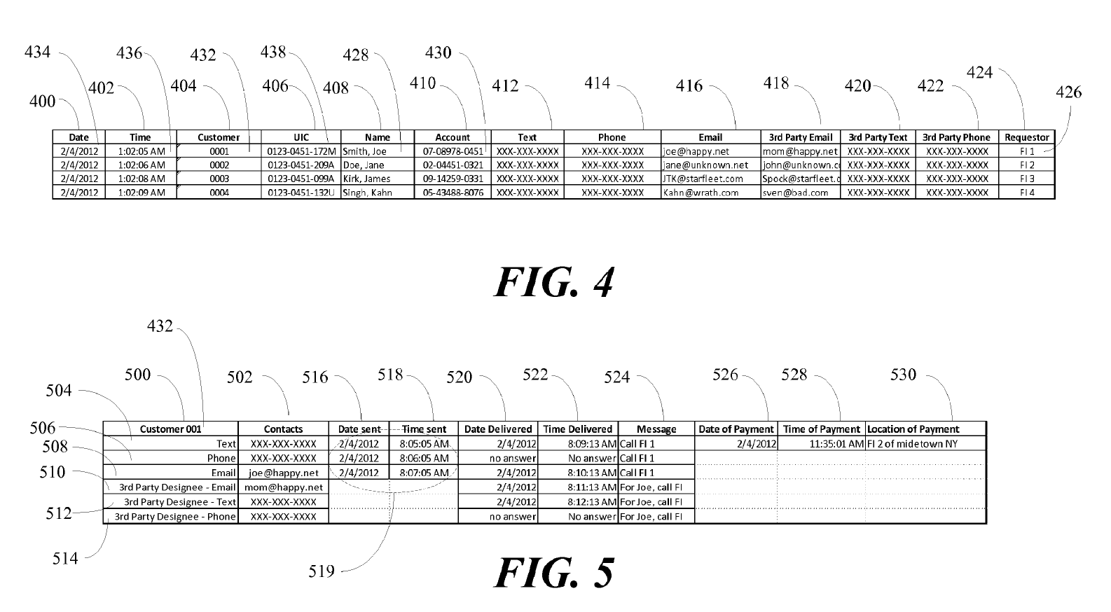

Turning to FIGS. 4 and 5, in FIG. 4, a table that includes tabular data regarding the NSF items and contact information for the Payors corresponding to the NSF items is shown. In this example, the table may include the date 400 that the NSF item was generated, the time 402 that NSF item was communicated to the FAMS 300, a customer (or other title name for identifying the Payor) number 404, the UIC 406 for the Payor, the name 408 of the Payor, account number 410 for the Payor account, contact information for sending text messages 412, contact information for sending pre-recorded or machine generated audio messages to a telephone number 414, contact information for sending emails 416, contact information for sending emails 418 to the 3^{rd} party designee, contact information for sending text messages 420 to the 3^{rd} party designee, contact information for sending pre-recorded or machine generated audio messages to a telephone number 422 corresponding to the 3rd party designee, and information regarding the requestor 424 that sent the NSF item to the FAMS 300. The requestor is a typically an FI such that, for example, the table shows that “FI 1” 426 is the requestor FI that desires that the FAMS 300 contact Payor “Kirk, James” 428 that has Payor account “09-14259-0331” 430. In this example, the FAMS 300 may assign a customer 404 number “0003” 432 with a time stamp of receipt having a data of “2/4/12” 434 and time “1:02:08 AM” 436 and a generated UIC 406 number of “0123-0451-099A” 438. Generally, this table is organized from the NSF list 366 and Payor contact list 368 by the FAMS 300 that may store this information into a FAMS 300 database.

In FIG. 5, a table that includes contact information related to customer 001 432 shown in FIG. 4. Unlike the table in FIG. 4, this table is specific to the NSF item and contact information for customer 001 432 of FIG. 4.

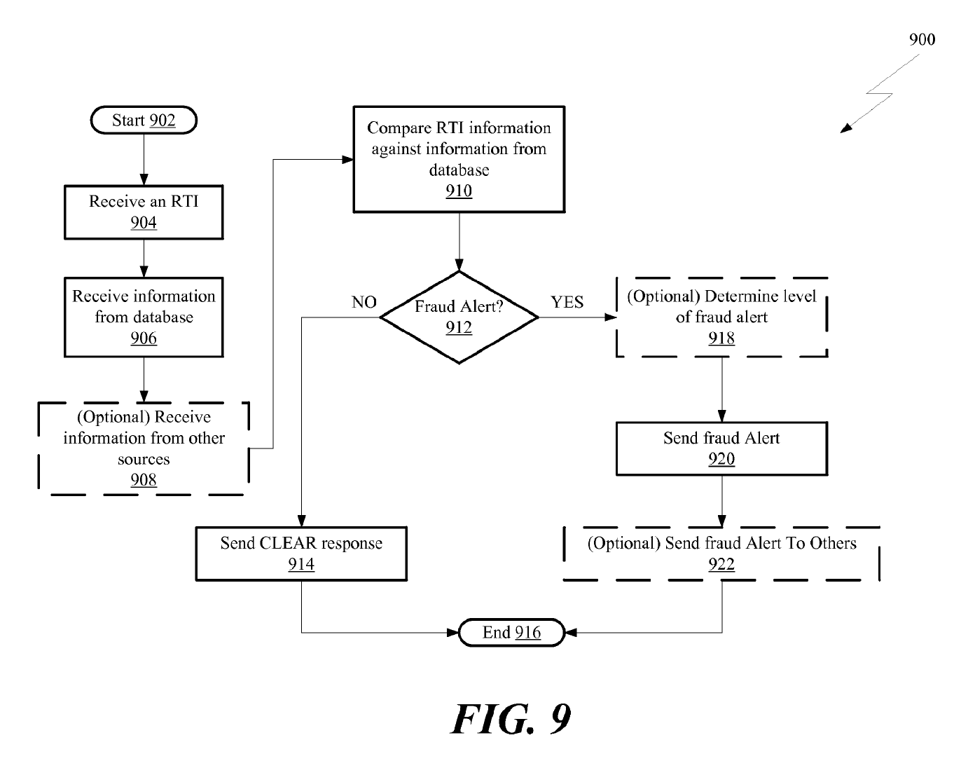

In this example, the table includes: the customer (or other title name for identifying the Payor) number 500; contact information 502 that corresponds to the contact information for sending text messages 504, contact information for sending pre-recorded or machine generated audio messages to a telephone number 506, contact information for sending emails 508, contact information for sending emails 510 to the 3^{rd} party designee, contact information for sending text messages 512 to the 3^{rd} party designee, contact information for sending pre-recorded or machine generated audio messages to a telephone number 514 corresponding to the 3^{rd} party designee; time stamp data of time of receipt of the NSF item(s) that includes the date sent 516 and time sent 518 from the FI (as an example, from 1^{st} FI 310), time stamp data of the date 520 and time 522 that the FAMS 300 contacted and sent the message to either the Payor or 3^{rd} party designee; and a copy of the message sent 524. The date and time delivered 520 and 522 columns would include the actual dates and times that the messages were delivered (i.e., the Payor/3^{rd} party designee has received the voice message or the FAMS 300 has left a voicemail on their respective telephones or the text or emails have been sent without being returned as undeliverable). If the messages were not delivered, the column entry would include a description of value indicating that there was “no answer,” “returned,” “undeliverable,” etc. Turning back to the columns for date sent 516 and time sent 518 from the FI, these columns also include other NSF items for that Payor (i.e., customer 001 432) that have occurred that day (i.e., date sent column 516). In this example, three NSF items 519 are shown in the FIG. 9. In this example, the time sent 518 for all three NSF items 519 vary from 8:05:05 AM to 8:07:05 AM; however, all three NSF items 519 may be sent by the FI to the FAMS 300 at the same time such as, for example, all three NSF items may be sent at 8:05:05 AM. The table may also include columns for noting the date 526 that the Payor and/or 3^{rd} party designee has made a payment including the time 528 that the payment was made, and the location 530 that the payment was made such as, for example, “2^{nd} FI of midetown, NY.”

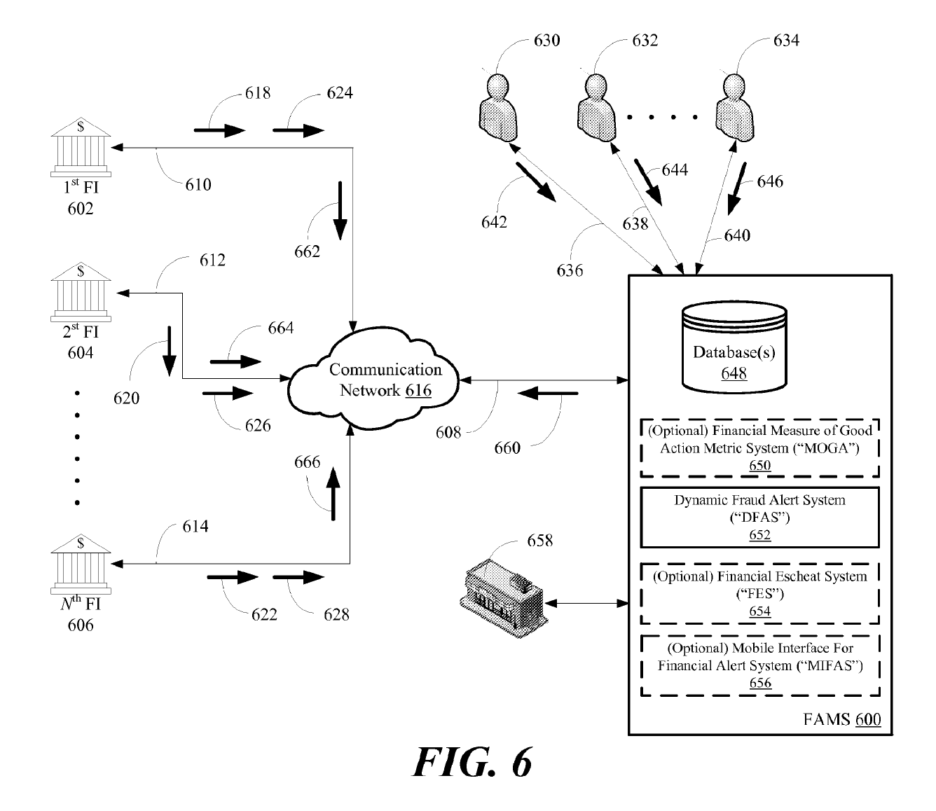

Based on the table showing the multiple requestors 424 shown in FIG. 4, we turn to FIG. 6. In FIG. 6, a block diagram of an example of an implementation of the FAMS 600 is shown in signal communication with a plurality of FIs. The FIs may be 1^{st} FI 602, 2^{nd} FI 604, through an N^{th} FI 606. It is appreciated by those skilled in the art that while only three FIs are shown in the figure, this is for simplicity and convenience and that there could be numerous FIs in signal communication with the FAMS 600, where “N” may represent any number greater than 3. Similar to the previous descriptions, the FAMS 600 may be in signal communication with the FIs 602, 604, and 606 via signal paths 608, 610, 612, and 614, and communication network 616, respectively. In this example, the FAMS 600 is a third-party entity which is independent of the FIs and may be part of the FAMS organization. The FAMS 600 may implemented across multiple sub-FAMS 600 systems that work together sharing all the FAMS organization databases (i.e., the different databases within either the single FAMS or multiple FAMS system).

In this example, the FAMS 600 may receive multiple NSF lists 618, 620, and 622 and Payor contact lists 624, 626, and 628, from the 1^{st} FI 602, 2^{nd} FI 604, and Nth FI 606, respectively. The FAMS 600 may also have a plurality of individual customers 630, 632, and 634. In this example, the Payor described in FIGS. 2 through 5 may be also an individual customer of the FAMS 600. Again, it is appreciated that while only three individual customers 630, 632, and 634 are shown in the figure, this is for simplicity and convenience and that there could be numerous individual customers of the FAMS 600. These individual customers 630, 632, and 634 may be in signal communication with the FAMS 600 via signal paths 636, 638, and 640 that may include the different forms of communications described earlier such as, for example, voice messages, text messages, and/or email messages. In this example, the individual customers 630, 632, and 634 may provide their contact and personal information 642, 644, and 646, respectively, to the FAMS 600.

As the FAMS 600 receives the NSF lists, Payor contact lists, and contact and personal information from the individual customers, the FAMS 600 may store all of the received data into one or multiple databases 648. From the information data in this, or these, database(s) 648, the FAMS 600 may organize and analyze this information data to provide a few optional features. These optional features would be to provide the FAMS 600 customers (both the FIs (602, 604, and 606) and the individual customers (630, 632, and 634) associated with the FAMS 600) with other types of financial alerts and information. Specifically, the FAMS 600 may include one of more modules such as, for example, an optional Financial Measure of Good Action Metric System (“MOGA”), an optional Dynamic Fraud Alert System (“DFAS”), an optional Financial Escheat System (“FES”), and an optional Mobile Interface for Financial Alert System (“MIFAS”).

In this example, the MOGA 650 may be utilized to create a historic rating of how customers (630, 632, and 634) resolve NSF occurrences on their Payor accounts (i.e., metric scores). In general, if they are timely in resolving the NSF occurrences and, therefore, do not cause their respective Payor FI to issue and/or send NPD notices to other FIs on their negotiable instruments that have caused the corresponding NSF occurrences, their MOGA 650 generated metric scores will be high. If, on the other hand, they are not timely in resolving the NSF occurrence and, therefore, do cause their respective Payor FI to issue and/or send NPD notices to other FIs on their negotiable instruments that have caused the corresponding NSF occurrences, their MOGA 650 generated metric scores will be low. These MOGA 650 generated metric scores may also take into account the number of NSF occurrences caused by Payors and the amounts that cause the NSF occurrences. These MOGA 650 generated metric scores may then be utilized by other customers to determine if they will accept a negotiable instrument from another person that has a MOGA 650 generated metric score. This may include individual customers 630, 632, and 634, and business entities that are FAMS 600 customers such, for example, retail store 658.

Another possible utilization of a MOGA 650 metric score is in a type of “credit score” for the individual customers 630, 632, or 634 because the metric score will help indicate how “good” an individual customer 630, 632, or 634 is in following through with their payments. Additionally, a high MOGA 650 metric score may allow the FAMS 300 to have some flexibility in how it deals with an individual customer 630, 632, or 634 when an NSF occurrence happens. Specifically, if an individual customer 630, 632, or 634 is a Payor that causes a NSF occurrence by generating and passing a negotiable instrument that causes an insufficient funds event, the FAMS 600 will receive the information on the NSF item caused by the Payor and will be able to compare the NSF item amount against the Payor's MOGA 650 metric score to determine the likelihood of the Payor paying on time the amount necessary to resolve the NSF occurrence. If the MOGA 650 metric score is high, the FAMS 600 may establish (unlike what was described earlier) a FAMS predetermined time period for the Payor to pay the FAMS 600 that is now greater than the FI predetermined time period. As described earlier, the FAMS predetermined time period is generally equal to or less than the FI predetermined time period so that the FAMS 600 has sufficient time to obtain a payment of funds from the Payor that caused the NSF occurrence. However, if that specific Payor has a history and a high MOGA 650 metric score that the FAMS 600 has been monitoring, the FAMS 600 may extend the FAMS predetermined time period to a time that is greater than the FI predetermined time period because the MOGA 650 may indicate that that this specific Payor is trustworthy enough to pay the amount required based on previous performances and that the FAMS 600 may take the risk of extending the time for the Payor to pay the funds even though that may expose the FAMS 600 to liability to FI if the Payor does not actually pay the FAMS 600. In this situation, the FAMS 600 may charge an additional fee (i.e., a payment time extension fee) to the Payor for extending the FAMS predetermined time period. This payment time extension fee may be part of subscription service if the Payor is a FAMS 600 customer. Based on this example, the FAMS 600 may either indicate to the corresponding FI that the Payor has made the payment and that the FI should pay the negotiable instrument that caused the NSF occurrence or FAMS 600 may send the required payment to the corresponding FI and then seek payment from the Payor. In this situation, the FAMS 600 could act, or facilitate, loaning time (optionally for a fee), or extending credit, a loan or a guarantee to the Payor based at least in part on the MOGA 650 metric score of the Payor.

Similar to MOGA 650, DFAS 652 would be a system and method that utilizes the information stored in the FAMS 600 database(s) 648. DFAS 652 may be utilized to constantly monitor the NSF items that are received by the different FIs against known Payor personal data. If multiple NSF items appear to be associated with the same Payor personal data (such as, for example, social security numbers, driver's license numbers, home addresses, telephone numbers, etc.) and these NSF items associated to the same Payor personal data are being received from different FIs, there is a chance that the Payor's personal data has been compromised and that someone is producing fraudulent negotiable instruments using the Payor's personal data. The DFAS 652 may then produce a fraud alert to all associated FIs and vendors (such as retail store 658) that informs these entities to hold, review, use caution or do not accept checks from this Payor until the fraud alert has been resolved. In the case of Payors that legitimately have different accounts at different FIs, this information should already be in the FAMS 600 database(s) and as such should not be a problem. An advantage of the DFAS 652 is that in today's economic environment, identity fraud is a large and growing problem and while there are generally laws that protect non-business consumers (i.e., the individual customers 630, 632, or 634) from financial fraud, there generally are no such laws protecting business against the same fraud. As such, if business such as the FIs, retail entities, etc. are properly warned against the potential fraud of negotiable instruments coming from a specific individual, or business, it allows those business to avoid potential loses by refusing to accept negotiable instruments for DFAS 652 altered accounts and/or Payors.

In addition to MOGA 650 and DFAS 652, the FES 654 is another system and method that utilizes the information stored in the FAMS 600 database(s) 648, a centralized hub which can request, mine or scrap information from member FIs, plus public information gathered from other public sources such as credit reports, news organization, social media, Internet search engines, etc. In general, a problem that many FIs have is that some accounts and/or safety deposit boxes become old and inactive but they cannot close out the accounts without legally contacting the owner(s) of the account. Unfortunately, sometimes the owner(s) become unavailable or simply cannot be found by the FI. In these situations, associated FIs may send an escheat list 662, 664, or 666 of account holders that they are looking for to resolve issues with old inactive accounts (or safety deposit boxes). The FES 654 will then do a search for the Payors on the escheat lists based on searching the FAMS 600 database(s) 648 and other available information from external sources which may include requests to member FIs to search or provide information from their databases. If a hit is found, the FES 654 may either contact the Payor (in this case also the old or inactive account or safety deposit box holder) directly for the FI (and charge an associated fee) or send the contact information to the requesting FI for them to make contact with the missing Payor.

Turning to the MIFAS 656, the MIFAS 656 may be a system and method that allows the FAMS 600 individual customers 630, 632, and 634 to have a mobile application on their mobile computers, mobile phones (such as smartphones), and/or mobile tablet devices. This application may have a graphical interface that interfaces with the FAMS 600 and shows the NSF items that the user needs to resolve, the payment required from the Payor, and the FAMS predetermined time period to make the payment.

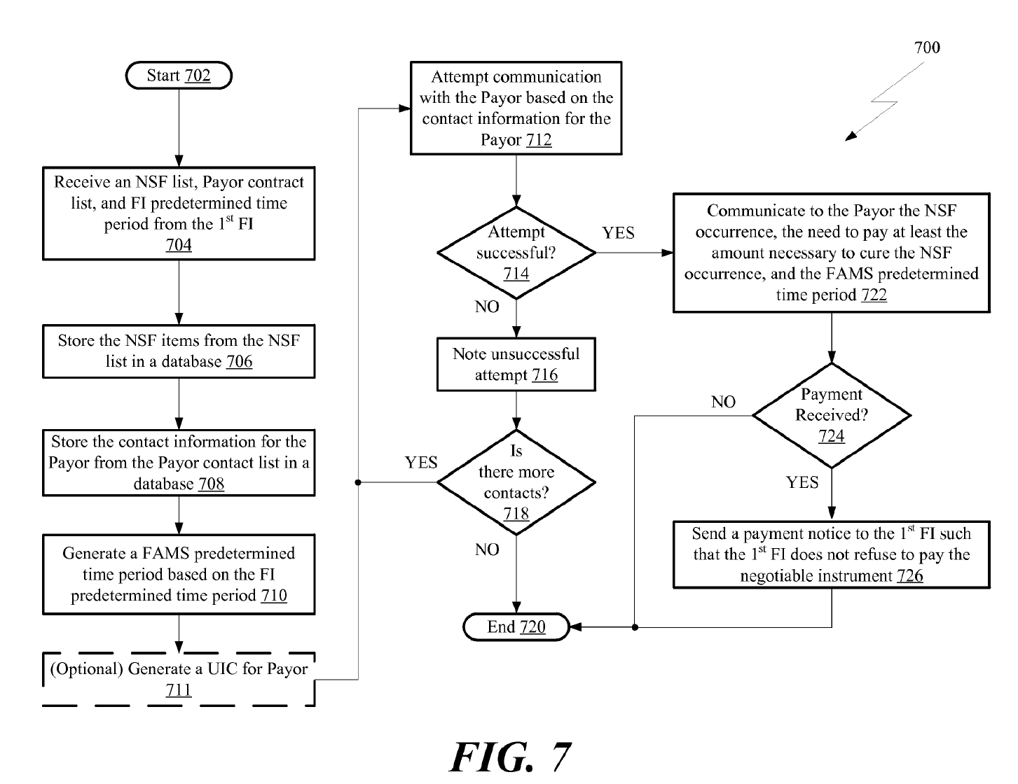

Turning to FIG. 7, a flowchart 700 of an example of an implementation of a method for reducing the occurrence of a non-payment event (by a 1^{st} FI) of a negotiable instrument listing a monetary amount (where the negotiable instrument was generated by a Payor having a Payor account at the 1^{st} FI) with the FAMS described in FIGS. 2, 3, and 6 is shown. The method starts 702 and, in step 704, the FAMS receives an NSF list, Payor contract list, and FI predetermined time period from the 1^{st} FI. The FAMS then stores, in step 706, the NSF items from the NSF list in a database and also stores, in step 708, the contact information for the Payor from the Payor contact list in a database. The database may be the same or different, as shown in FIG. 3, as the database for the NSF items 330 and the database for Payors 332. The FAMS notes the time stamps in the NSF list that list a time and date for each NSF item that indicates when the 1^{st} FI became discovered the NSF occurrence that corresponds to the NSF item. The FAMS then generates, in step 710, a FAMS predetermined time period based on the FI predetermined time period. The FAMS may also optionally generate a UIC for the Payor in step 711. The FAMS then extracts the contact information for the Payor from the Payor contact list and attempts to communicate, in step 712, with the Payor based on the contact information for the Payor. The attempt may include, for example, attempting to call the Payor using the listed home, work, or mobile telephone number. If the attempt is not successful, in decision step 714, the FAMS notes, in step 716, the unsuccessful attempt and stores it in a database with a time stamp that shows the date and time that the attempt was made. The FAMS then determines, in decision step 718, whether there is additional contact information that will allow the FAMS to attempt contact via a different method such as, for example, telephone numbers for sending texts, one or more email addresses, contact information for a 3^{rd} party designee, etc. If there is additional contact information, the process will then repeat step 712 through decision step 718. If there is no more contact information and the FAMS has exhausted all possible contracts and no actual contact has been made, the process then ends 720 and the FAMS will not inform the 1^{st} FI to not refuse to pay the negotiable instrument, which will result in the 1^{st} FI refusing to pay the negotiable instrument or an NPD notice being sent by the 1^{st} FI if the negotiable instrument had been paid or credited earlier.

If, instead, one of the forms of communication from the FAMS to the Payor (or 3^{rd} party designee) is successful, the process continues to step 722 where the FAMS communicates with the Payor which may include communicating to the Payor the NSF occurrence, the need to pay at least the amount necessary to cure the NSF occurrence, and the FAMS predetermined time period in which the Payor must pay to prevent the 1^{st} FI refusing to pay the negotiable instrument. The FAMS then time stamps the date and time that the communication was made with Payor or 3^{rd} party designee and saves it in a database which may be, for example, the database for the NSF items. The FAMS then waits for the Payor's payment. If the payment is not received before the expiration of the FAMS predetermined time period the FAMS, in decision step 724, does not inform the 1^{st} FI to not refuse payment of the negotiable instrument, which will result in the 1^{st} FI refusing to pay the negotiable instrument or a NPD notice being sent by the 1^{st} FI if the negotiable instrument had been paid or credited earlier.

If, instead, a payment is received from the Payor within the FAMS predetermined time period, the FAMS, in decision step 724, will proceed to step 726 where the FAMS will send a payment notice to the 1^{st} FI such that the 1^{st} FI does not refuse payment of the negotiable instrument or send a NPD notice . The negotiable instrument is then covered and the payment of the negotiable instrument proceeds through the normal process until it ends 720.

As an alternative to this process, it is appreciated that in steps 712 through 722, FAMS may attempt to communicate with the Payor using all the provided contact information, for example, the FAMS may determine that the Payor contact information includes a home telephone number, a mobile telephone number, a telephone number for receiving texts, an email address, and 3^{rd} party contact information. In this example, the FAMS would attempt to contact every contact point provided whether or not any of the contact points works or is able to receive a message.

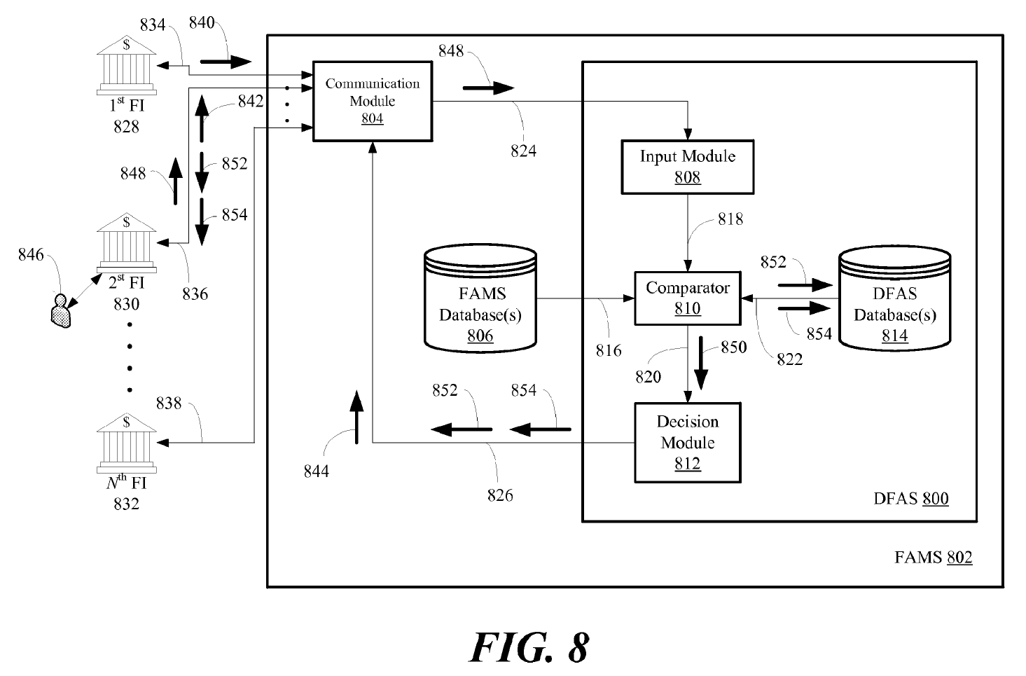

Turning back to FIG. 6, the FAMS 600 includes a DFAS 652 that is a system and method that utilizes the information stored in the FAMS 600 database(s) 648 and may be utilized to monitor the NSF items that are received by the different FIs against known Payor personal data. That monitoring may be at predetermined times, regular intervals or constantly. The DFAS 652 may be also a system and method that receives requests to investigate (“RTI”) from customers of the DFAS 652 and utilizes the information available in the FAMS 600 database(s) 648 and a DFAS database (not shown), which may include databases FAMS or DFAS have access to (not shown), to determine if there is potential fraud. Specifically, turning to FIG. 8, a block diagram of an example of an implementation of a DFAS 800 is shown. In this example, the DFAS 800 is part of the FAMS 802. The FAMS 802 may include all of the systems, modules, components, and/or devices described in the FAMS 300 shown in FIG. 3. For convenience, only a communication module 804 and FAMS database(s) 806 are shown but it is appreciated that all other modules described in FIG. 3 may also be present in the FAMS 802 even though not explicitly shown in the figure. In this example, the FAMS database(s) may include the database of NSF items 330, Payor database 332, and other databases. The DFAS 800 may include an input module 808, comparator 810, decision module 812, and DFAS database(s) 814 where the DFAS database(s) 814 may be one or more databases.

Those of ordinary skill in the art will recognize that the DFAS 800 does not require the complete the FAMS or all process steps to monitor potential fraud. Rather, the DFAS 800 compares the RTI against NSF items available, received, or collected by the DFAS 800 to identify patterns or anomalies that are predictive of fraud.

In this example, the comparator 810 may be in signal communication with FAMS database(s) 806, (alternatively it may be in contact with one or more non FAMS databases which contain records of NSF events that are also connected to a specific identity (person or entity)), input module 808, comparator 810, decision module 812, and DFAS database(s) 814 via signal paths 816, 818, 820, and 822, respectively. The communication module 804 may also be in signal communication with the input module 808 and decision module 812 via signal paths 824 and 826, respectively. The communication module 804 may be in signal communication with a plurality of FIs of which, for convenience, only three with be shown, however, it is appreciated that there could be many more FIs. Specifically, the communication module 804 may be in signal communication with a 1^{st} FI 828, 2^{nd} FI 830, and N^{th} FI 830 via signal paths 832, 834, and 836, respectively. Again, it is appreciated that “N” represent the number of FIs.

In one example of operation, the DFAS 800 may be utilized to monitor the NSF items that are received by the different FIs against known Payor personal data (i.e., Payor identity). Specifically, if both 1^{st} FI 828 and 2^{nd} FI 830 produce NSF items 840 and 842 and both of these items appear to be associated with the same Payor personal data (such as, for example, social security numbers, employer identification number “EIN,” driver's license numbers, home addresses, telephone numbers, etc.), there is a chance Payor's personal data (i.e., the Payor's identity) has been compromised and that someone has obtained Payor's personal data is fraudulently generating negotiable instruments attributed to Payor using the Payor's personal data. In this example, by checking the information provided by the 1^{st} FI 828 and 2^{nd} FI 830, in relation to the NSF items 840 and 842, against the FAMS database(s) 806 and/or the DFAS database(s) 814, the DFAS 800 may be able to determine if one or both of the NSF items 840 and 842 are the results of fraud or if an identity theft is suspected. If there is fraud, or compromised identity, the DFAS 800 may then produce a fraud alert 844 that may be sent to one or more associated FIs (which may be subscribers) and vendors (which are utilizing DFAS to pro-actively guard against fraud and identity theft) that informs these entities to either raise their level of security with respect to this Payor and/or not accept checks from this Payor until the fraud alert has been resolved.

In some instance the historical information from past RT is in the FAMS and/or DFAS databases is compared against the RTI for a predetermined period of time. A non-limiting list of time periods include but are not limited to at least about 12 hours, at least about 24 hours, at least about 48 hour, at least about 72 hours, at least about one week and at least about one month.

In the case of Payor's that legitimately have different accounts at different FIs, this information should already be in the FAMS database(s) 806 and as such should not be a problem. However, if associated data such as address, telephone numbers, email, mobile phone, driver's license, passport, image, or other biometric data (fingerprint, voice, face, DNA, hand print and the like) is different, then a warning may be appropriate. An advantage of the DFAS 800 is that in today's economic environment, identity fraud is a large and growing problem and while there are generally laws that protect non-business consumers from financial fraud, there generally are no such law protecting business against the same fraud. As such, if business such as the FIs, retail entities, etc. are properly warned against the potential fraud of negotiable instruments coming from a specific individual, or business, it allows those business to avoid potential loses by refusing to accept negotiable instruments flagged by the DFAS 800. This is an advantage because in today's financial industry and others that either extend credit and/or sell goods utilize traditional fraud systems that are typically identity theft and fraud systems that tend to be an exercise in chasing a bad actor. These known systems tend to be reactive instead of pro-active. The DFAS 800 described in pro-active.

In another example of operation, the DFAS 800 may be utilized by customer FIs or other business entities as a way of verifying potential customers of the FI or business entities. Specifically, if the 2^{nd} FI 830 is approached by potential customer 846 attempting to open an account at the 2^{nd} FI 830, the 2^{nd} FI 830 may send an RTI 848 to the DFAS 800 to investigate the potential customer 846 for potential fraud. It is appreciated that the potential customer 846 may be an individual or business entity. The RTI 848 is received via the communication module 804 of the FAMS 802 and sent to the input module 808 of the DFAS 800. The RTI 848 may include all the personal identification information (i.e., contact and identity information) for the potential customer 846 that the 2^{nd} FI 830 possesses. The DFAS 800 then compares the RTI 848 against the data in both the FAMS database(s) 806 and DFAS database(s) 814 in the comparator 810. The results of the comparisons 850 are passed to the decision module 812, where the decision module 812 may include rule and decision engines, state machines, a processor with associated decision software, threshold circuitry, etc. The decision module 812 then determines whether the comparator 810 can confirm the identity potential customer 846 as being secure or not. Based on this determination, the decision module 812 determines whether to issue a fraud alert 852 or an CLEAR response 854, both of which are passed through the communication module 804 to the 2^{nd} FI 830. If the decision module 812 determines that the identity of the potential customer 846 is secure (i.e., there are no flags, alarm alerts, or other anomalies) the decision module 812 will issue the CLEAR response 854. If, on the other hand, the decision module 812 determines that the identity of the potential customer 846 is not secure (i.e., the potential customer appears with variations in the database records) the decision module 812 will issue the fraud alert 852. A copy of the CLEAR response 854 and fraud alert 852 with all the associated data may be stored in the DFAS database(s) 814 for future comparisons. In this example, the fraud alert 852 may not be a “true fraud” alert in that it may only indicate that there are anomalies associated with the potential customer 846 such as, for example, inconsistent address, multiple addresses, inconsistent phone number, multiple phone numbers, disconnected phone, bounced email, multiple email addresses, multiple addresses, inconsistent spouse information, multiple bank accounts, past fraudulent activities with same or similar names, image, voice, fingerprint, facial recognition, other biometric information. As a result, the fraud alert 852 may include different levels of concern based on the anomalies found that may range, for example, at 1 to 5, where level one is the lowest concern and 5 is the highest.

In this example, the DFAS 800 may compile its own data in the DFAS database(s) 814 that is separate from the FAMS database(s) 806 but includes information from the FAMS database(s) 806. Additionally, the DFAS 800 may include a public information module (not shown) that is configured to search and data mine public sources and records as part of it comparison process with the comparator 810.

The DFAS 800 may also proactively send notifications (i.e., fraud alerts) to additional FIs (such as, for example, 1^{st} FI 828 through the N^{th} FI 830. These additional FIs may be FIs that have previously engaged the DFAS 800 to perform an RTI on a potential customer. In this fashion a FI that previously request the RTI may update incorrect records, add additional data and more preferably can flag an account, person, or entity that has been identified by the DFAS 800 as having anomalous results. The same is true of entities that are subscribers of the DFAS 800 (or have provided data to the DFAS 800 in the past) which may include leasing companies, lessors of real property or other entities.

It is known that bank fraud related to identity theft, in particular, relies on a bad acting individual to leverage a false identity in a short period of time. Scenarios include the bad actor opening a bank account and using a stolen identity with false contact information to hide the account from the person whose identity has been compromised. The DFAS 800 by having access to data on individuals and entities from prior RTI operations and other databases can flag an anomalous set of information for the bank dynamically, in near real time, potentially before a bad actor is able to steal money via an overdraft on the account.

Another scenario is the bad actor opening multiple bank accounts at different FIs and utilizing overdraft mechanisms to cover NSF checks. Because the FIs (being stolen from) will require several days under the traditional system to even send out the NSF notice and then will spend additional weeks to determine the account needs to be closed. Therefore, during the short period during which the greatest damage may occur, there is no reporting by any FI to traditional agglomerators of records of non-performing bank customers. As such, even a FI that subscribes to a traditional system of checking will be vulnerable during the short time frame these bad actors tend to act during. Accordingly, under the traditional systems, bad actor could simultaneously open bank accounts at several institutions write a series of bad check at each bank and utilize the overdraft mechanism to cover the checks. As described earlier, this type of activity would be flagged by the DFAS 800 issuing the fraud alert 844. In this example, the fraud alert 844 may report to subscribing FIs or other entities as soon as an anomaly such as an individual (or entity) opening multiple bank accounts at multiple institutions in a specified time frame.

Turning to FIG. 9, a flowchart 900 is shown of an example of an implementation of a method for receiving RTIs from customers of the DFAS and utilizing the information available to the DFAS to determine if there is any potential fraud. The process starts 902 by the DFAS receiving an RTI, in step 904, from a 1^{st} FI. The RTI will request that the DFAS check a potential customer (i.e., a person or entity) via their social security number or other identification number (“ID”), Tax ID number, or Employer ID number, date of birth, business name and other identifiers for consistency of address, telephone, email and other personal information such as a fingerprint, retina image, or other biometric data and the like. In this example, the RTI will include the identification information that the 1^{st} FI has received from the potential customer.

The DFAS then queries and receives, in step 906, information from the DFAS available databases. The DFAS available databases may include the DFAS database (or databases) 814 and the FAMS database (or database) 806, which may include the database of NSF items 330 and database of Payors 332. The DFAS may optionally also receive, in step 908, information for other sources such as, for example, publically available sources. The DFAS then compares, in step 910, the RTI provided information against the information in the available databases and optional information from other sources. The results are passed to a decision engine of the DFAS. The DFAS then determines, in decision step 912, whether there are any anomalies. If there are no anomalies the DFAS sends, in step 914, a CLEAR response to the 1^{st} FI and the process ends 916. If, on the other hand, the DFAS does determine, in decision step 912, that are some anomalies, the process then continues to optional step 918. In optional step 918, the DFAS determines types of anomalies and establishes a level for the fraud alert that will be generated. The fraud alert is then generated and sent, in step 920, and the DFAS may optionally also send this fraud alert to other subscriber FI or other entities, in step 922. The process then ends in step 916.

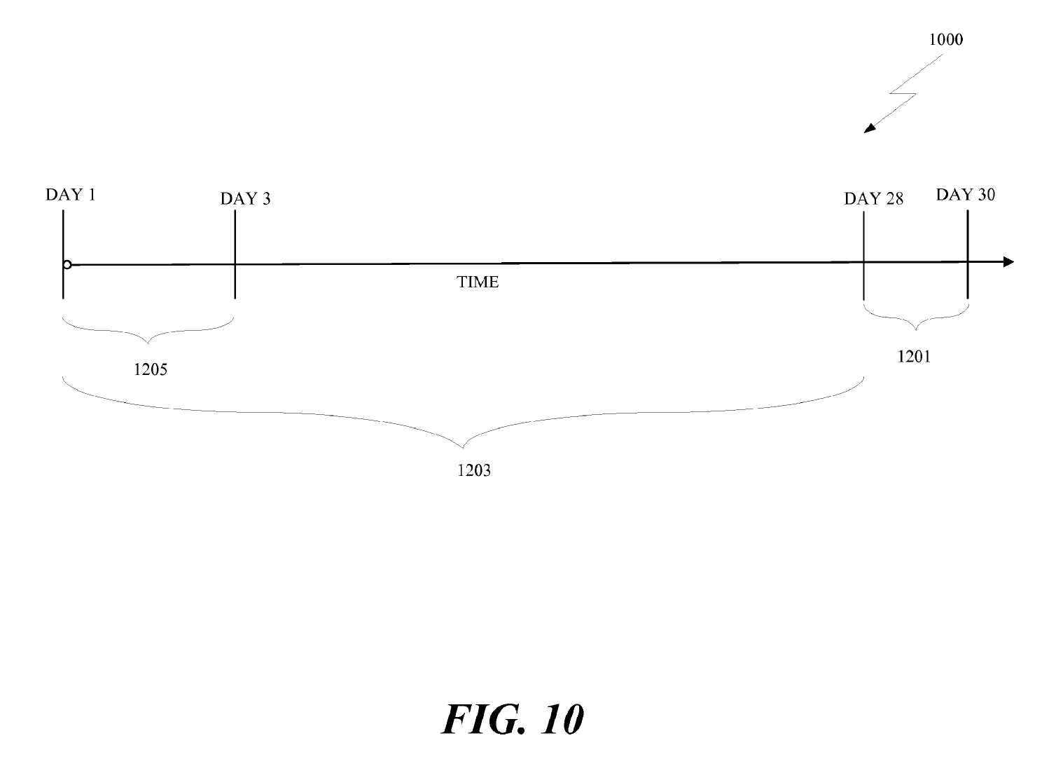

Turning now to FIG. 10, a time line 1000 is illustrated as a comparison of DFAS pro-active fraud watch to traditional methods and systems. Traditionally, FI reporting of accounts that are being closed due to non-responsive/non-performing account holders by FIs to traditional agglomerators of records of non-performing bank customers are after 28 to 30 days (i.e., time period one 1201). However, that allows at least 27 days (i.e., time period two 1203) during which a bad actor may operate to exploit an identity theft and steal from persons, business and FIs via taking the funds legitimately placed in the account by the legitimate account holder and via leveraging any overdraft offered by the FIs and corresponding to such accounts. With the DFAS monitoring the situation, this time period may be reduced by a third (time period 1205), where the DFAS can monitor for anomalies in NSF items wherein the identity of the Payor (i.e., social security numbers, EIN and the like) does not correspond to the contact or personal information associated with the accounts at each FI reporting the NSF items. Preferable the DFAS monitors a time (time period 1203) between the first NSF item and the time when traditional agglomerators of non-performing account reports to FIs. Additionally, the DFAS may monitor during the one-third time period (time period 1205) covering the zero to three days from the first NSF item because this is when FIs and the account holder are most vulnerable to attack.

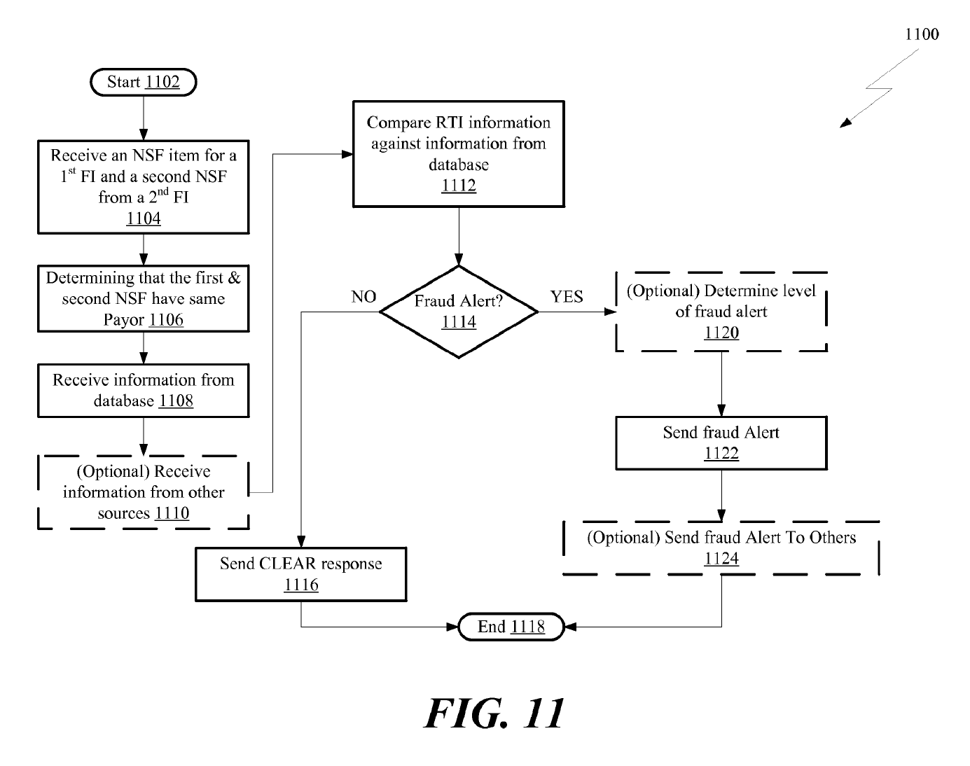

In FIG. 11, a flowchart 1100 is shown of an example of an implementation of a method for monitoring NSF items (from different FIs against the same Payor) that are provided to the FAMS with the DFAS and utilizing the information available to the DFAS to determine if there is any potential fraud. The process starts 1102 by the FAMS receiving a first NSF item for a 1^{st} FI and a second NSF item for a 2^{nd} FI in step 1104. Either the FAMS or DFAS then determines that that the first NSF item and second NSF item are identified as being caused by the same Payor in step 1106.

The DFAS then queries and receives, in step 1108, information from the DFAS available databases. The DFAS available databases may include the DFAS database (or databases) 814 and the FAMS database (or database) 806, which may include the database of NSF items 330 and database of Payors 332. The DFAS may optionally also receive, in step 1110, information for other sources such as, for example, publically available sources. The DFAS then compares, in step 1112, the first NSF and second NSF provided information against the information in the available databases and optional information from other sources. The results are passed to a decision engine of the DFAS. The DFAS then determines, in decision step 1114, whether there are any anomalies. If there are no anomalies the DFAS sends, in step 1116, a CLEAR response to the 1^{st} FI and the process ends 1118.

If, on the other hand, the DFAS does determine, in decision step 1114, that are some anomalies, the process then continues to optional step 1120. In optional step 1120, the DFAS determines types of anomalies and establishes a level for the fraud alert that will be generated. The fraud alert is then generated and sent, in step 1122, and the DFAS may optionally also send this fraud alert to other subscriber FI or other entities, in step 1124. The process then ends in step 1118.

It will be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

What is claimed is:

1. A Dynamic Fraud Alert System (“DFAS”) for producing a fraud alert based on a received request to investigate (“RTI”) a potential customer, where the RTI is received from a requesting entity, and where the RTI includes potential customer information provided by the potential customer, the DFAS comprising:
a DFAS database;
a comparator;
a decision module,
the comparator is in signal communication with both the DFAS database and decision module,
wherein the DFAS database includes historical information from past RTIs,
wherein the comparator is configured to compare the potential customer information against the historical information from the DFAS database, and
wherein the decision module determines whether there is an anomaly in the comparison of the potential customer information against the historical information from the DFAS database and, in response to the anomaly, produces a fraud alert.

2. The DFAS of claim 1,
wherein comparator is also in signal communication with a Financial Alert Management System (“FAMS”) database, having FAMS database information, and
wherein the comparator is configured to compare the potential customer information against the historical information from the DFAS database and the FAMS database information.

3. The DFAS of claim 2, wherein the FAMS database includes a database of NSF items and a database of Payors.

4. The DFAS of claim 3, further including
a public information module,
wherein the public information module is signal communication with the comparator, and
wherein the public information module is configured to search and data mine public sources and records.

5. A method for producing a fraud alert based on a received request to investigate (“RTI”) a potential customer, where the RTI is received from a requesting entity, and where the RTI includes potential customer information provided by the potential customer, the method comprising:
receiving, from a DFAS database, historical information from past RTIs;
comparing the potential customer information against the historical information from the DFAS database;
determining whether there is an anomaly in the comparison of the potential customer information against the historical information from the DFAS database;
producing a fraud alert in response to determining that there is an anomaly in the comparison of the potential customer information against the historical information from the DFAS database.

6. The method of claim 5, further including
receiving, from a Financial Alert Management System (“FAMS”) database, FAMS database information, and
wherein comparing the potential customer information against the historical information from the DFAS database further includes comparing the potential customer information against the historical information from the DFAS database and FAMS database information.

7. The method of claim 6, further including
receiving public source information from searched and data mined public sources and records, and
wherein comparing the potential customer information against the historical information from the DFAS database and FAMS database information further includes comparing the potential customer information against the historical information from the DFAS database, FAMS database information, and public source information.

8. The method of claim 6, further including sending the fraud alert to other entities besides the requesting entity.

9. The method of claim 8, wherein the other entities are subscribers of the DFAS.

10. The method of claim 8, wherein the other entities are entities that have previously sent an RTI.

11. The method of claim 5, the method further comprising the historical information from past RTIs is compared for a predetermined period of time.

12. The method of claim 11, wherein the predetermined period of time is one of at least about 12 hours, at least about 24 hours, at least about 48 hour, at least about 72 hours, at least about one week and at least about one month.
